(19) United States
(12) Patent Application Publication
(10) Pub. No.: US 2026/0252997 A1
(43) Pub. Date: Aug. 27, 2026

(54) Dynamic Account Provisioning For Workflow Documents In A Workflow Management Service

(71) Applicant: NetApp, Inc., San Jose, CA (US)

(72) Inventors: Khiem Chan Truong, South San Francisco, CA (US); Joseph Edward Carpenter, Sunnyvale, CA (US); Xiaoyun Zhu, Cupertino, CA (US); Winggo Tse, San Francisco, CA (US); Samarth Wadhwa, San Jose, CA (US); Yuk Chan, San Jose, CA (US)

(73) Assignee: NetApp, Inc., San Jose, CA (US)

(21) Appl. No.: 19/063,776

(22) Filed: Feb. 26, 2025

(51) Int. Cl. G06Q 10/0633

(52) U.S. Cl. CPC G06Q 10/0633

(57) ABSTRACT

The disclosure describes a workflow management service that dynamically provisions workflow documents across multiple accounts to avoid reaching document limits imposed by a compute provider. The workflow management service initially allocates workflow documents to a central account, which manages workflow execution and distribution. The workflow management service also provisions shard accounts dedicated to hosting and executing workflow documents. When the number of workflow documents in the central account or an existing shard account approaches the compute provider's imposed limit, the workflow management service provisions a new shard account and redirects future workflow documents to the new shard account.

### BACKGROUND

Cloud compute providers facilitate the creation and execution of “workflow documents” that orchestrate tasks for managing cloud resources and automated tasks. These tasks may include provisioning and configuring virtual machine instances, setting up data buckets, scheduling routine maintenance, or generating notifications for messaging systems, for example. Compute providers may impose limits on the number of workflow documents that can be registered or maintained within a single account, often enforced on a per-region basis.

As organizations increasingly migrate their operations to cloud-based infrastructure, they frequently rely on workflow management services to execute workflow documents on their behalf. For example, a workflow management service might execute workflow documents to perform actions such as launching additional compute instances or backing up databases across numerous customer environments. A workflow management service can rapidly approach the document limit imposed by the compute provider, even when supporting a relatively modest number of customers. Moreover, as customer adoption expands, the total number of workflow documents can scale significantly, amplifying the risk of hitting the workflow document limits.

Workflow management services can submit requests to compute providers to increase the workflow document limit, but such requests often require considerable time for review and approval. By the time a higher limit is granted, growing demand may again drive the service close to the new limit, creating an ongoing cycle of repeated quota requests and potential service bottlenecks.

### SUMMARY

The disclosure describes a workflow management service that distributes workflow documents across multiple accounts to avoid exceeding limits imposed by compute providers. The workflow management service is configured to determine that a number of workflow documents in a central account has exceeded a (predetermined) threshold. Exceeding the threshold indicates that the number of workflow documents approaches a document limit imposed by a compute provider. The workflow management service provisions a new shard account in response to the determination. The shard account is configured to host and execute additional workflow documents. The workflow management service thus proactively provisions new accounts to accommodate increasing numbers of workflow documents, alleviating the above-described issues.

These and other features and aspects of various examples may be understood in view of the following detailed discussion and accompanying drawings.

### BRIEF DESCRIPTION OF THE DRAWINGS

FIG. 1A illustrates a computing environment in an implementation.

FIG. 1B illustrates regions of the computing environment in an implementation.

FIG. 2 illustrates a process for provisioning shard accounts in an implementation.

FIG. 3 illustrates a process for allocating workflow documents in an implementation.

FIG. 4 illustrates an operational sequence in an implementation.

FIG. 5A illustrates another operational sequence in an implementation.

FIG. 5B illustrates another operational sequence in an implementation.

FIG. 6 illustrates a computing environment in an implementation

FIG. 7 illustrates another process for allocating workflow documents in an implementation.

FIG. 8 illustrates another computing environment in an implementation.

FIG. 9 illustrates another process for allocating workflow documents in an implementation.

FIG. 10 illustrates another computing environment in an implementation.

FIG. 11 illustrates another process for allocating workflow documents in an implementation.

FIG. 12 illustrates a computing system suitable for implementing the various operational environments, architectures, environments, processes, scenarios, sequences, and frameworks discussed below with respect to the other Figures.

### DETAILED DESCRIPTION

As organizations increasingly rely on cloud computing solutions, they often automate a wide range of tasks across their cloud resources. Compute providers, such as Amazon Web Services (AWS), offer the ability to create and run workflow documents (also referred to as Systems Manager documents or SSM documents), to facilitate this automation. These workflow documents may include scripts for managing diverse operations, such as provisioning virtual machines (VMs), configuring network settings, or generating notifications for messaging systems. By consolidating these tasks into predefined workflows, organizations can eliminate repetitive manual actions and free IT personnel to focus on higher-level tasks. For example, rather than having personnel repeatedly troubleshoot or provision VMs manually (e.g., by directly entering commands into an API or command-line interface), workflow documents allow those processes to run automatically, improving operational efficiency and reducing the risk of human error. Beyond supplying a base set of workflow documents, compute providers typically allow customers and third-party services to develop and deploy additional workflow documents.

Many organizations rely on third-party workflow management services to execute workflow documents on behalf of the organizations, in order to optimize compute resources, perform various automated tasks, and reduce overall cloud operating costs. For example, a workflow management service may deploy a “rightsizing” workflow document that adjusts CPU and memory allocations for applications, providing that applications operate with appropriate resource levels.

In general, a workflow management service may be a cloud orchestration, automation, and response platform. By hosting and executing workflow documents on behalf of customers, the workflow management service automates and orchestrates diverse tasks across one or more cloud providers. The workflow management service may provide a user interface to customers that allows the customers to create and monitor workflow documents. In some implementations, the workflow management service may provide customers with the ability to build custom workflow documents, for example, by “dragging and dropping” multiple steps into an overall process. The workflow management service may also provide other services, such as allowing users to schedule workflow documents for execution (e.g., periodically every morning at a particular time). The workflow management service may also maintain logs of execution of workflow documents, including input and output data associated with each step of a workflow document, for example.

Table 1 below provides an exemplary list of workflow documents that may be deployed by a workflow management service.

TABLE 1

| Workflow Name | Summary of Workflow Operations |
|---|---|
| Application Outage Root | Determine root cause of an |
| Cause Analysis | application outage and |
| | post results to a communication channel. |
| Application Rightsizing | Update resource requests values (e.g., CPU and |
| | Memory) for containerized applications. |
| Compute Provider Health | Detect and analyze service outages from the |
| Analysis | compute provider. |
| Application Performance | Identify application performance issues and |
| Error Handling | initiate remedial actions. |

It is noted that Table 1 is merely illustrative; workflow management services may host many other workflow documents to address diverse operational scenarios. For example, IT administrators and DevOps engineers can use workflow documents to streamline and automate the deployment, configuration, and management of applications and services (e.g., executing actions on one or more instances, automating maintenance and deployment tasks, defining policies, etc.). Examples include, but are not limited to, tasks like scaling applications, performing backups, monitoring system health, and handling failure recovery. The specific content of these files can be written in JSON (JavaScript Object Notation) or YAML (YAML Ain′t Markup Language) formats. These formats are both human-readable and machine-parsable which allows for easy creation and management.

Unfortunately, compute providers impose document limits identifying the allowed number of workflow documents that can be deployed within a single account. An account represents a workspace where a user or organization hosts and manages cloud resources. The document limits may be enforced on a per-region basis. For example, a cloud compute provider may limit workflow documents for an account at 500 workflow documents in each region (e.g., “US-West-1,” “US-East-2,” and so on). As a result, workflow management services seeking to deploy large numbers of automated workflows on behalf of multiple customers risk reaching the document limits when using a single account in a region, preventing the deployment of additional workflow documents. While compute providers may allow customers to submit requests to increase the workflow document limit (e.g., from 500 to 5,000), such requests frequently involve significant delays in processing and approval. Moreover, even if the limit increase is granted, the new limits may be quickly reached as the workflow management service continues to onboard new customers and expand workflow deployments. This scenario may create a cycle of repeatedly submitting new requests to increase limits, which can lead to operational bottlenecks and hinder scalability. Furthermore, a compute provider may not grant some limit increase requests, potentially leading to a situation in which the workflow management service does not have capacity to deploy new workflow documents.

The disclosure describes a system for dynamic provisioning of new shard accounts and distribution of workflow documents among the new shard accounts, providing scalability and mitigating the need to repeatedly submit document increase requests to the compute provider. The workflow management service described includes a central account that executes workflow documents and manages the distribution of additional workflow documents to one or more shard accounts. These shard accounts are tasked with hosting and executing these workflow documents on behalf of the central account.

The central accounts and shard accounts are distinct accounts with a compute provider, each operating a workspace associated with a unique account identifier. The central account and shard accounts may each be associated with an account identifier. A single account can operate across multiple geographic regions (e.g., US-West-1, US-East-1, etc.). The central account functions as the primary orchestration layer, receiving workflow documents requests from customers and allocating the workflow documents to either itself (the central account) or one of the shard accounts. The shard accounts serve as separate workspaces recognized by the compute provider; these shard accounts are tasked with executing additional workflow documents on behalf of the central account.

The central account monitors the number of workflow documents in the central account. When this number exceeds a threshold (or mark indicative of a state or point where a shift in operating logic may be desirable), the central account initiates the scaling up of a shard account. The threshold may be predetermined as an indicator that the number of documents in the central account is approaching the document limit. For example, where the document limit is 5,000, the threshold may be set at 3,000 (60% of the document limit) or 4,000 (80% of the document limit), etc. In some implementations, the threshold may be a dynamic threshold that the workflow management service determines based on various factors. For example, the workflow management service may measure the rate at which new workflow documents are registered, and adjust the threshold based on the rate. Thus, when new workflow documents are added at a slower rate, the threshold might be set closer to the document limit. Conversely, when new workflow documents are added at a faster rate, the threshold might be set lower to allow for enough time to provision a new shard account before the document limit is reached. Initiating the scale-up of a shard account may include initiating an automated process in which the workflow management service submits a request to the compute provider to scale up a new account.

In other implementations, initiating the scale-up may include generating an alert, indicating that the threshold has been exceeded, to an administrator of the workflow management service. The administrator, in turn, may manually prepare and submit a request to scale up a shard account and submit the request to the compute provider. Similarly, as the provisioned shard account approaches its document limit (i.e., exceeds a predetermined threshold), the workflow management service may provision additional new shard accounts to provide that the workflow management service maintains capacity as the total number of workflow documents scales up.

Customers of the workflow management service may submit requests to the workflow management service to register new workflow documents for their cloud resources. When the workflow management service receives such a request, the central account of the workflow management service first assesses the current capacity of the central account. If the central account has available capacity (i.e., the number of workflow documents has not reached the document limit), the central account may store and execute the workflow document directly within the central account. However, if the central account is at capacity (e.g., the central account includes 5,000 workflow documents where the document limit is 5,000) the workflow management service allocates the new workflow document to a shard account. This shard account may be proactively scaled up (as described above) such that it is ready to execute workflow documents when the central account reaches its limit.

Shard accounts are independently provisioned with services to host and execute workflow documents on behalf of the central account. These services may include, for example, an automation engine that orchestrates the steps defined in each workflow document, as well as execution services such as Lambda functions that perform tasks such as provisioning or configuring VM instance or looping actions in the workflow execution.

The dynamic provisioning of new shard accounts and allocation of workflow documents to these shard accounts provides robust scalability, enabling the workflow management service to handle increasing volumes of workflow documents without exceeding the document limits imposed by the compute provider. The workflow management service thus avoids a situation in which there is not available capacity to host additional workflow documents and avoids the submission of repeated limit increase requests to the compute provider. Furthermore, this architecture enhances compute efficiency by distributing workflow executions across multiple shard accounts, optimizing resource utilization, and reducing latency through parallel processing.

Various embodiments of the present technology provide for a wide range of technical effects, advantages, and/or improvements to computing systems and components. For example, various embodiments may include one or more of the following technical effects, advantages, and/or improvements: 1) non-routine and unconventional dynamic implementation of workflow management services; 2) non-routine and unconventional operations for distributing workflow documents for hosting and execution; 3) integration of a role-chaining mechanism to allow shard accounts to inherit execution privileges from a central account; 4) use of non-traditional system components to provide comprehensive workflow execution services; 5) dynamic provisioning of new shard accounts to enhance scalability and flexibility, and/or 6) non-routine and unconventional use of compute provider accounts.

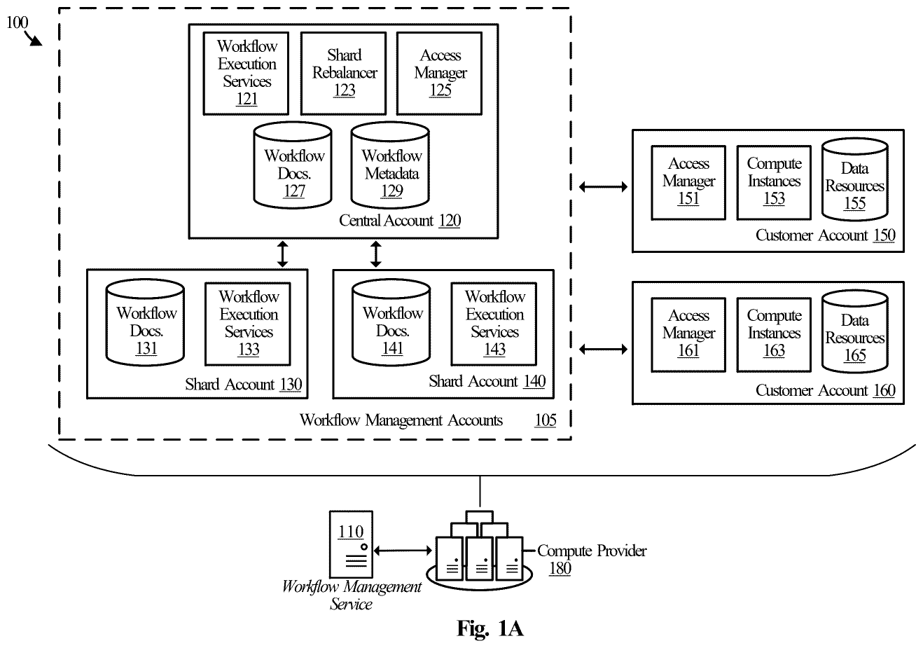

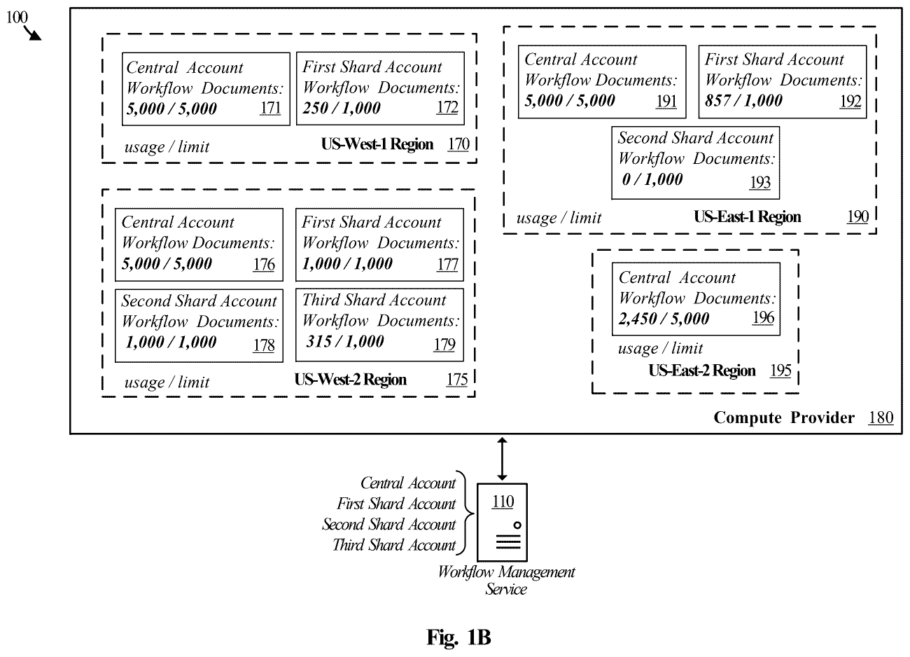

FIG. 1A illustrates computing environment 100 according to some implementations. Computing environment 100 includes workflow management service 110, customer account 150, customer account 160, and compute provider 180. It is noted that in various implementations, computing environment 100 may include additional elements not shown in FIG. 1A for clarity. For example, computing environment 100 may include any number of customer accounts serviced by workflow management service 110.

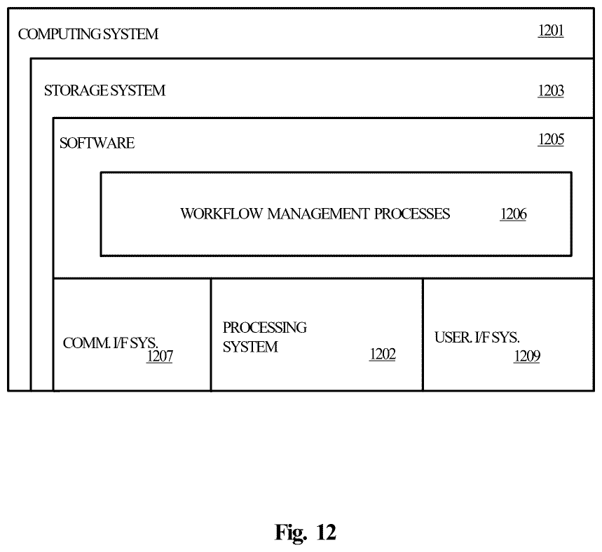

Compute provider 180 represents a service provider that offers compute resources, such as virtual machine (VM) instances and data storage solutions like S3 buckets. Clients of compute provider 180 manage these resources through distinct accounts, which serve as dedicated workspaces for organizing, configuring, and controlling their compute resources. As illustrated in FIG. 1A, these accounts include central account 120, shard account 130, shard account 140, customer account 150, and customer account 160. Each account functions as an environment for clients to efficiently manage their resources, apply specific configurations, and execute workflow documents. Execution of processes within the accounts (such as execution of workflow documents, workflow execution service 121 and shard rebalancer 123) may occur in VM instances, containers, lambda functions, or in servers operated by compute provider 180, which may be represented by computing system 1201 of FIG. 12.

Compute provider 180 facilitates the deployment and execution of workflow documents within each account. A workflow document is a configuration file (e.g., a JSON or YAML file) that defines a sequence of automated tasks designed to manage and manipulate compute resources. Each workflow document includes a series of actionable steps for various tasks. Examples include, but are not limited to, provisioning and configuring VM instances, setting up and managing data storage solutions like S3 buckets, performing routine maintenance tasks, and executing scaling operations to adjust resource allocation based on demand. Some examples of workflow documents are illustrated in Table 1 above.

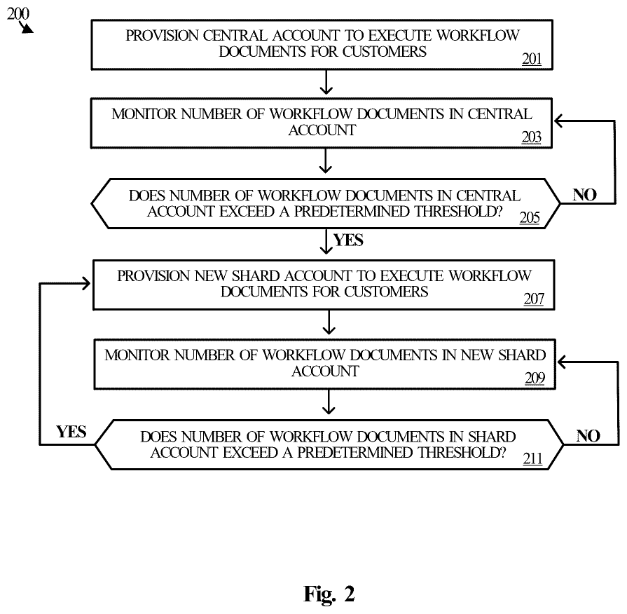

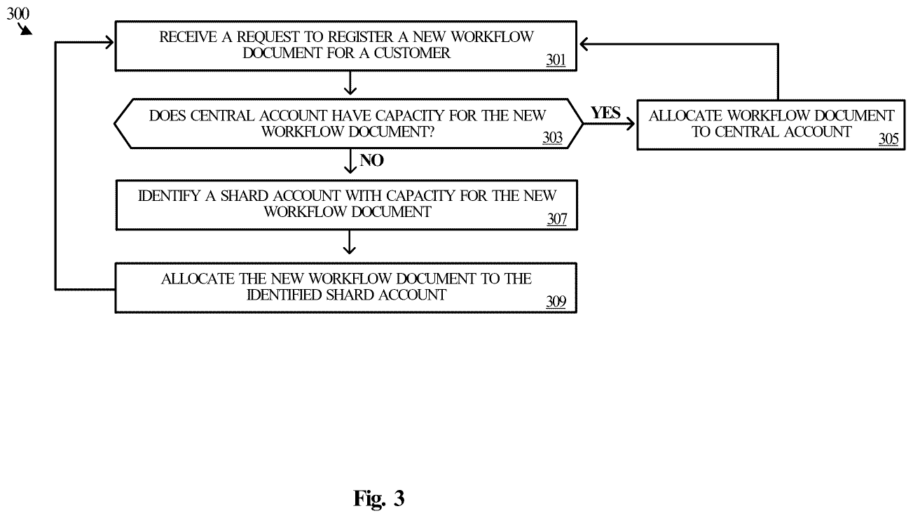

Compute provider 180 may enforce limitations on the number of workflow documents that can be registered and maintained within each account. For instance, a compute provider may set a document limit of 500 workflow documents per account in a specific region (e.g., US-East-1 as illustrated in FIG. 1B), beyond which no additional documents can be created without requesting a limit increase. These limits pose challenges for workflow management service 110, which may execute workflow documents on behalf of many customers. Workflow management service 110 addresses this issue by scaling up shard accounts 130, 140 and allocating workflow documents to these various shard accounts, as discussed in greater detail below with respect to processes 200, 300 of FIGS. 2 and 3. The document limit may be imposed by compute provider 180 on a per-region basis, as discussed in greater detail in relation to FIG. 1B below.

Workflow management service 110 is representative of a service for managing, hosting, and executing workflow documents for customers of workflow management service 110. These workflow documents may perform automated tasks for computing resources of customer accounts 150, 160, such as compute instances 153, 163, and data resources 155, 165. While two customer accounts 150, 160 are shown in FIG. 1A for clarity, workflow management service 110 may serve many additional customer accounts, and host workflow documents for each of these customer accounts. As a result of hosting multiple workflow documents on behalf of multiple customer accounts (e.g., customer accounts 150, 160) the total number of workflow documents may approach or exceed the per-account document limit of compute provider 180. To accommodate increasing numbers of workflow documents, workflow management service 110 may provision multiple workflow management accounts 105, including central account 120, which executes workflow documents and manages distribution of workflow documents, and shard accounts 130, 140, which host and execute workflow documents on behalf of central account 120. While two shard accounts 130, 140 are illustrated in FIG. 1A for brevity, workflow management service 110 may employ any number of shard accounts in order to accommodate high numbers of workflow documents.

Central account 120 includes workflow documents 127 workflow execution services 121, shard rebalancer 123, workflow metadata 129, and access manager 125. For example, in some instances, central account 120 may be a compute provider account associated with backend platform of workflow management service 110.

Workflow documents 127 are representative of workflow documents that are allocated to and executed by central account 120. These can include various workflow documents executed on behalf of customer accounts 150, 160, examples of which are illustrated above in Table 1. As the number of workflow documents approaches a limit, shard rebalancer 123 may provision shard accounts, as described below.

Workflow documents 127 facilitate various compute management tasks on behalf of customers of workflow management service 110. Workflow management service 110 may provide an interface that allows customers to select different optimization services, such as rightsizing (adjusting resource allocations for applications) and cluster autoscaling (managing the size and number of VMs in the customer's computing cluster). When a customer enables an optimization service (such as rightsizing) workflow management service 110 determines and registers an associated workflow document (e.g., a rightsizing workflow document) with compute provider 180.

Workflow execution services 121 are representative of services in central account 120 that facilitate the execution of workflow documents 127. Workflow execution services 121 may include an automation engine that manages the execution of tasks in the workflow documents, an API service such as a Runbook API, which serves as an interface for initiating and managing workflow creation and execution requests. Workflow execution services 121 may further include script execution services such as Snippets Lambda (responsible for executing discrete workflow steps) and Loop Lambda (responsible for executing looping process of workflow documents).

Workflow execution services 121 may further include an event management service (e.g., EventBridge), which triggers execution of workflow documents 127 based on predefined conditions such as scheduled intervals or system state changes. Workflow execution services 121 may further include a monitoring and logging service (e.g., execution monitor) that tracks workflow progress, stores execution metadata, and provides status updates. It is noted that these examples are representative only; workflow execution services 121 may include other services not listed here for brevity.

Shard rebalancer 123 is representative of a service for allocating workflows among central account 120 and shard accounts 130, 140. Shard accounts 130, 140 may be compute provider 180 accounts that will host sub systems required to store and execute workflow automation documents. Shard Rebalancer 123 continuously monitors the number of workflow documents stored and executed within each account (i.e., central account 120 and shard accounts 130, 140) and compares these numbers against predefined thresholds (or against benchmarks indicating that a load rebalancing may be appropriate). This predefined threshold may be a percentage of the document limit; for example, where the document limit is 5,000 the predetermined threshold may be 3,000 (60% of the document limit) or 4,000 (80% of the document limit). Upon determining that the number of documents in central account 120 or a shard account 130, 140 has exceeded the threshold, shard rebalancer 123 initiates the provisioning of a new shard account 130 or 140 configured to host and execute additional workflows. The new shard account 130 or 140 is provisioned with the workflow execution services 133, 143, which may be substantially similar to workflow execution services 121 of central account 120.

Once the new shard account 130, 140 is operational, shard rebalancer 123 may allocate incoming workflow requests to the newly provisioned shard account 130, 140, thereby distributing the load and preventing any single account from exceeding the document limit imposed by compute provider 180. In some implementations, shard rebalancer 123 may continue allocating incoming workflow documents to central account 120 until central account 120 reaches the document limit, as discussed below in relation to process 300. Specifically, while shard rebalancer 123 may proactively scale up a new shard account when the threshold is exceeded, shard rebalancer may continue to allocate workflow documents to central account 120 beyond the threshold until the number of workflow documents in central account reaches the document limit (e.g., 5,000 documents), thus providing for the efficient utilization of accounts in workflow management service 110. Shard Rebalancer 123 updates workflow metadata 129 maintained in the central account 120 to accurately map each workflow document to its designated shard account 130, 140.

Workflow metadata 129 is representative of a data repository maintained in central account 120 which maps each workflow document to the specific account where it is allocated; either central account 120 or one of the shard accounts 130, 140. Workflow metadata 129 data structure may include fields such as workflow ID (identifying a workflow document) and account ID (identifying either central account 120 or one of shard accounts 130, 140), as illustrated for example in Table 2 below. Shard rebalancer 123 utilizes workflow metadata 129 to track the number of workflow documents allocated to each account.

TABLE 2

| Workflow ID | Customer ID | Account ID |
|---|---|---|
| Workflow-A | Customer-A | Central |
| Workflow-B | Customer-A | Shard-1 |
| Workflow-C | Customer-B | Shard-2 |

Table 2 illustrates metadata for three exemplary workflow documents; though it is noted that workflow metadata 129 may include metadata for many workflow documents. The first workflow document (Workflow-A) is allocated to central account 120, the second workflow document (Workflow-B) is allocated to a first shard account (e.g., shard account 130) and the third workflow document (Workflow-C) is allocated to a second shard account (e.g., shard account 140). Table 2 further includes a “Customer ID” field associating each workflow with a customer for which the workflow document is executed. “Customer-A” may correspond, for example, to customer account 150, while “Customer-B” may correspond to customer account 160. It is noted that Table 2 illustrates three workflow documents for exemplary purposes; in practice workflow management service 110 may maintain workflow metadata 129 for many workflows executed for any number of customers of workflow management service 110.

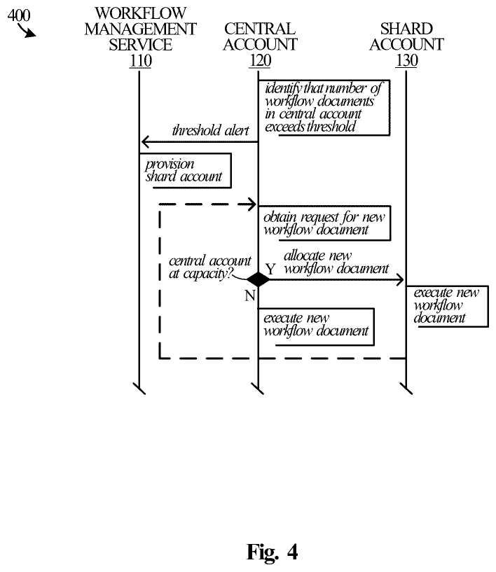

Access manager 125 is representative of a service managing role-based permissions within central account 120. Access manager 125 may grant shard accounts 130, 140, a central account role that allows shard accounts 130, 140 to execute workflow documents on behalf of central account 120. In turn, access managers 151, 161 of customer accounts 150, 160 may grant a customer account role to central account 120, providing that shard accounts 130, 140 may chain roles to execute workflow documents on behalf of customer accounts 150, 160, as described below in relation to sequence 400 of FIG. 4 below.

Shard accounts 130, 140, as described above, are provisioned by central account 120 and allocated workflow documents for execution, represented by workflow documents 131, 141. To facilitate execution, each shard account 130, 140 is provisioned with workflow execution services 133, 143, which provide the infrastructure for processing and executing assigned workflows.

In some implementations, shard accounts 130, 140 are provisioned with a full suite of workflow execution services, allowing them to operate independently of central account 120. This configuration, referred to as full-isolation, provides that each shard account 130, 140 is equipped with all services (e.g., EventBridge, Loop Lambda, and Snippets Lambda, among others) to fully execute workflow documents without relying on the central account 120. This approach may enhance execution efficiency by distributing workload execution entirely within shard accounts.

In other implementations, shard accounts 130, 140 may follow a semi-isolation model, in which only a subset of workflow execution services are provisioned within the shard account, while certain execution tasks are still handled by central account 120. For example, a shard account may be provisioned with Loop Lambda and EventBridge but rely on central account 120 for executing certain services such as Snippets Lambda. This semi-isolation model may reduce costs by maintaining centralized execution for shared services.

To facilitate either the full-isolation or semi-isolation model, administrators of workflow management service 110 can interact with compute provider 180 through a management console. The administrators can specify which services should be enabled in each shard account (e.g., enabling or disabling Snippets Lambda, or other workflow-execution components). The compute provider 180 then provisions the shard account accordingly, instantiating the requested workflow execution services 133, 143.

Customer accounts 150, 160 represent cloud-based accounts operated by customers who utilize workflow management service 110 to manage their compute environments. Customer accounts 150, 160 provide execution environments where customers provision, configure, and operate their own compute resources. Each customer account 150, 160 includes compute instances 153, 163, and data resources 155, 165, which are representative of compute resources of customer accounts 150, 160, that are managed by the workflow documents in central account and shard accounts 130, 140.

Compute instances 153, 163 may be Virtual Machines (VMs), provisioned by compute provider 180. Data resources 155, 165 may be storage resources such as S3 buckets. Workflow documents executed in central account 120 and shard accounts 130, 140 perform automated tasks on these resources, such as automated scaling of compute instances 153, 163, or automating data backups of data resources 155, 165.

Access managers 151, 161 is representative of a service managing role-based permissions within respective customer account 150, 160. As noted above, in some implementations access managers 151, 161 may grant a customer account role to central account 120, providing that shard accounts 130, 140 may chain roles to execute workflow documents on behalf of customer accounts 150, 160, as described below in relation to sequence 400 of FIG. 4.

FIG. 1B illustrates computing environment 100, including multiple operating regions of compute provider 180. Computing environment includes workflow management service 110 and compute provider 180.

Compute provider 180 may operate in multiple different regions 170, 175, 190, 195, including US-West-1 region 170, US-West-2 region 175, US-East-1 region 190, and US-East-2 region 195 as illustrated in FIG. 1A. Each region 170, 175, 190, 195 may reflect a cluster of data centers in a particular geographic area. Compute provider 180 may utilize these regions to provide low latency of users of computing resources, facilitate compliance with varying local regulations, and allow for geographic distribution of computing resources and applications. It is noted that regions 170, 175, 190, 195 illustrated in FIG. 1B are merely examples and represent a subset of regions operated by compute provider 180. In various implementations, compute provider 180 may include different and/or additional regions.

Compute provider 180 may impose document limits on a per-account and per-region basis. In the example in FIG. 1, the central account (e.g., central account 120 of FIG. 1A) has a document limit of 5,000, while the shard accounts (e.g., shard accounts 130, 140 of FIG. 1A) has a document limit of 1,000. Accordingly, central account 120 is allowed up to 5,000 documents in each region 170, 175, 190, 195, while each shard account is allowed up to 1,000 documents in each region 170, 175, 190, 195.

Workflow management service 110, as described in relation to FIG. 1A above, registers accounts with compute provider 180. In the example of FIG. 1B, workflow management service 110 has registered four accounts: a central account (e.g., central account 120 of FIG. 1A), a first shard account (e.g., shard account 130 of FIG. 1A) a second shard account (e.g., shard account 140 of FIG. 1A) and a third shard account (e.g., an additional shard account similar to shard accounts 130, 140). Each of these accounts may be assigned a specific account identification by compute provider 180. Further, each of the accounts may operate in separate workspaces, provided by compute provider 180, in each region 170, 175, 190, 195. As noted above, compute provider 180 imposes a document limit on each of these accounts, such that an account may not operate more workflow documents than the limit in a given region 170, 175, 190, 195. FIG. 1A illustrates examples of operations of the accounts of workflow management service 110 in each region, 170, 175, 190, 195, each of which is described in turn below.

Region 170 represents the “US-West-1” region. As shown in FIG. 1B, workflow management service 110 currently hosts 5,000 workflow documents in the central account for region 170 (represented by central account workflow documents 171). Because the central account has exceeded a threshold (e.g., a threshold of 3,000 documents, 4,000 documents, etc.) and reached its per-region document limit of 5,000 documents (i.e., 5,000/5,000), workflow management service 110 provisioned a first shard account in region 170 to handle additional workflow documents (e.g., according to process 200 described below). In the illustrated example, the first shard account now holds 250 documents (represented by first shard account workflow documents 172), and any newly registered documents for region 170 are allocated to the first shard account (e.g., according to process 300 described below).

To provision accounts in a region, workflow management service 110 requests additional capacity from compute provider 180, either by creating a brand-new account or enabling a previously existing account to operate in a new region (e.g., enabling the first shard account in region 175 where it already hosts workflow documents in region 175). For instance, an IT administrator or an automated component of workflow management service 110 may call an API of compute provider 180 to allocate a new account ID, specifying the desired region, associated resource limits, and the workflow execution services (e.g., workflow execution services 121, 133, 143 of FIG. 1A).

Region 175 represents the “US-West-2” region. As shown in FIG. 1B, workflow management service 110 currently hosts 5,000 workflow documents in the central account for region 175 (represented by central account workflow documents 176). Because the central account has exceeded a threshold and reached its per-region document limit of 5,000 documents (i.e., 5,000/5,000), workflow management service 110 provisioned a first shard account in region 170 to handle additional workflow documents (e.g., according to process 200 described below). As the first shard account has exceeded a threshold (e.g., a threshold of 600 documents, 800 documents, etc.) and reached its document limit of 1,000 (represented by first shard account workflow documents 177), workflow management service 110 has further provisioned a second shard account in region 175. Likewise, as the second shard account 178 has exceeded a threshold and reached its limit of 1,000 (represented by second shard account workflow documents 178) workflow management service 110 has further provisioned a third shard account in region 175. In the illustrated example, the third shard account now holds 315 documents (represented by third shard account workflow documents 179), and any newly registered documents for region 170 are allocated to the third shard account (e.g., according to process 300 described below). Region 175 illustrates that workflow management service 110 may continually scale up shard accounts to accommodate an increasing number of workflow documents in a given region.

Region 190 represents the “US-East-1” region. As shown in FIG. 1B, workflow management service 110 currently hosts 5,000 workflow documents in the central account for region 190 (represented by central account workflow documents 191). Because the central account has exceeded a threshold and reached its per-region document limit of 5,000 documents, workflow management service 110 provisioned the first shard account in region 170 to host additional workflow documents (e.g., according to process 200 described below). The first shard account currently hosts 857 workflow documents (represented by first shard account workflow documents 192). While the first shard account has not reached the limit of 1,000, it has exceeded a predetermined threshold (e.g., 600 documents or 800 documents) indicating that the number of workflow documents is approaching the document limit. Accordingly, workflow management service 110 has preemptively provisioned the second shard account in region 190 (represented by second shard account 140 of FIG. 1A), according to process 200 discussed below. The central account may continue to allocate workflow documents to the first shard account until the first shard account is at capacity (i.e., 1,000 workflow documents in the example of FIG. 1B). Region 190 illustrates that workflow management service 110 may proactively provision new accounts in a region before the limit is reached, such that when existing accounts (e.g., the central account and first shard account) are at capacity, the new shard account (e.g., the shard account) is ready to host newly allocated workflow documents.

Region 195 represents the “US-East-2” region. As shown in FIG. 1B, workflow management service 110 currently hosts 2,450 workflow documents in the central account for region 195 (represented by central account workflow documents 196). Because the central account has not yet exceeded a threshold (e.g., 3,000 documents, 4,000 documents, etc.) workflow management service 110 has not provisioned additional shard accounts in region 195.

FIGS. 2 and 3 illustrate processes 200, 300. Process 200 illustrates a process for proactively provisioning new shard accounts 130, 140, while process 300 illustrates a process for allocating incoming workflow documents among central account 120 and shard accounts 130, 140. In some implementations, processes 200, 300 may be performed in parallel; for example, while workflow management service 110 may proactively scale up shard accounts 130, 140 according to process 200, workflow management service 110 may allocate incoming workflow documents among central account 120 and shard accounts 130, 140, according to process 300.

FIG. 2 illustrates a resource management process performed by workflow management service 110, represented by process 200. Process 200 is employed by a computing device to provide resource management, an example of which is provided by computing system 1201 of FIG. 12. Process 200 may be implemented in program instructions (software and/or firmware) by one or more processors of the computing device. The program instructions direct the computing device to operate as follows, referring parenthetically to the steps in FIG. 2.

To begin, workflow management service 110 provisions central account 120 to execute workflow documents on behalf of customers (step 201). Provisioning central account 120 involves submitting a request to compute provider 180 to create and register the account. Step 201 may further include scaling up workflow execution services 133 within central account 120, such as Step Functions, Lambda functions, EventBridge, and Runbook APIs. Central account 120 initially receives workflow document requests from customer accounts 150 (examples of which are set forth in Table 1 above), 160 and allocates them for execution. Initially, workflow documents are allocated to central account 120 itself. Central account 120 may execute these workflow documents on behalf of multiple customers (represented by customer accounts 150, 160 of FIG. 1A). As the number of workflow documents in central account 120 approaches a threshold, workflow management service 110 provisions shard accounts 130, 140 for workflow execution, as discussed further below.

Workflow management service 110 monitors the number of workflow documents in central account 120 (step 203). As workflow documents are added to central account 120, shard rebalancer 123 monitors workflow metadata (as shown for example in Table 2 above) to determine how many workflow documents are allocated to central account 120.

Workflow management service 110 determines if a number of workflow documents in central account 120 exceeds a pre-determined threshold (step 205). The predetermined threshold may be a fixed threshold percentage of the compute provider's document limit. For example, if the document limit is 5,000, the threshold may be set at 3,000 (60%) or 4,000 (80%). It is noted that provisioning a new shard account 130, 140 may take a significant amount of time (e.g., several hours), due to various tasks associated with setting up account including performing verification and payment, configuring permissions, and provisioning workflow execution services. Setting the predetermined threshold below the compute provider limit (in this case 5,000) provides that central account 120 has availability for future workflow document allocations while a new shard account 130 or 140 is being spun up (as discussed with respect to process 300 below in FIG. 3).

In some implementations, the threshold may be dynamically determined. For example, workflow management service 110 may determine a threshold (or transition point or indicator) based on a rate of new workflow document requests. That is, the threshold may be determined as a function of the rate of increase of workflow documents. Central account 120 may monitor incoming workflow document requests and determine the rate of increase (e.g., the number of new workflow documents requests over a predetermined time period (e.g., per minute, hour, or day). The determined threshold (or transition point or indicator) may be inversely related to the rate of increase. For example, when the rate of increase is high, central account 120 may set a lower threshold to allow for enough time to scale up a new shard account before central account reaches capacity. Conversely, when the rate is low, central account 120 may set a higher threshold. For example, if the central account 120 identifies one-hundred new workflow document requests per hour, central account 120 might set the threshold at 4,000 (80% of the document limit of 5,000) so a new shard account 130, 140 can be provisioned in time. By contrast, if the rate is only ten new workflow documents per hour, central account 120 might raise the threshold to 4,500 (90% of the document limit) before provisioning a new shard account.

If the number of workflow documents exceeds the threshold (i.e., the number of workflow documents is greater than or equal to the threshold), process 200 proceeds to step 207. If the number of workflow documents does not exceed the threshold, process 200 returns to step 203 for continued monitoring.

When the number of workflow documents exceeds the threshold, workflow management service 110 provisions a new shard account 130 or 140 to execute workflow documents for customers (step 207). In some implementations, central account 120 may automatically provision shard account 130, 140 upon detecting that the threshold has been exceeded. For example, shard rebalancer 123 may continuously track the number of workflow documents and trigger an automated request to compute provider 180 when the threshold is reached. In other implementations, central account 120 may generate an alert when the threshold is exceeded. This alert indicates that the threshold has been exceeded may be provided to an administrator of workflow management service 110. Upon receiving the alert, the administrator may manually prepare and submit a request to compute provider 180 to create a new shard account 130 or 140.

Workflow management service 110 monitors the number of workflow documents in the newly provisioned shard account 130, 140 (step 209). As workflow documents are added to shard account 130, 140 (as discussed further below in relation to process 300), shard rebalancer 123 monitors workflow metadata (as shown for example in Table 2 above) to determine how many workflow documents are allocated to each newly provisioned shard account 130, 140. To perform the monitoring, shard rebalancer queries workflow metadata 129, which maintains a record of workflow allocations across shard accounts 130, 140, as illustrated in Table 1 above.

Workflow management service 110 determines if a number of workflow documents in the new shard account 130, 140 exceeds a pre-determined threshold (step 211). It is noted that compute provider 180 may provide the same limit to shard accounts 130, 140 as central account 120 in some implementations. In other implementations, shard accounts 130, 140 may have a different associated document limit imposed by compute provider 180. For example, central account 120 may have a document limit of 5,000 after receiving a limit increase from compute provider 180. However, compute provider 180 may deny a limit increase for shard accounts 130, 140, meaning that the associated document limits may remain at the initial amount (e.g., 500 documents). In some implementations, compute provider 180 may increase the limit by a different or smaller amount (e.g., up to 1,00 documents for shard accounts 130, 140). The predetermined threshold may be a threshold percentage of the compute provider's document limit. For example, if the document limit for shard accounts 130, 140, is increased to 1,000, the threshold may be set at 600 (60%) or 800 (80%).

If the number of workflow documents exceeds the threshold (i.e., the number of workflow documents is greater than or equal to the threshold, process 200 proceeds to step 207, where an additional new shard account 130, 140 is provisioned. If the number of workflow documents does not exceed the threshold, process 200 returns to step 209 for continued monitoring. Accordingly, workflow management service 110 may iteratively provision new shard accounts 130, 140 to provide for scaling up of workflow documents while remaining within the document limits of compute provider 180.

FIG. 3 illustrates a resource management process performed by workflow management service 110, represented by process 300. Process 300 is employed by a computing device to provide resource management, an example of which is provided by computing system 1201 of FIG. 12. Process 300 may be implemented in program instructions (software and/or firmware) by one or more processors of the computing device. The program instructions direct the computing device to operate as follows, referring to the steps in FIG. 3.

Workflow management service 110 receives a request to register a new workflow document for a customer (step 301). Step 301 may be triggered when the customer requests a new service from workflow management service 110 through an interface or API call. For example, workflow management service 110 may receive a request to register a rightsizing workflow document in central account 120 for execution on behalf of customer account 150 or 160.

Workflow management service 110 determines if central account 110 has capacity to host the new workflow document (step 303). To make this determination, shard rebalancer 123 queries workflow metadata 129 to determine the number of workflow documents currently allocated to central account 120. If the number of workflow documents in central account 120 equal to the compute provider limit (e.g., 5,000), central account 120 does not have capacity for hosting the new workflow document, and process 300 proceeds to step 307. If the number of workflow documents in central account is less than the document limit (e.g., 2,000, 4,000, 4,999, etc.), workflow management service 110 determines that central account 120 has available capacity, and process 300 proceeds to step 305. Accordingly, workflow management service 110 may fill up the capacity of central account 120 before allocating new workflow documents to shard accounts 130, 140. It is noted that these shard accounts 130, 140 may be proactively provisioned according to process 200 (since the threshold is set below the document limit in process 200); thus, shard accounts 130, 140 may be available for document allocation by the time central account 120 runs out of capacity.

When workflow management service 110 determines that central account 120 has available capacity for new workflow documents, workflow management service 110 allocates the new workflow document to central account 120 (step 305). Process 300 then returns to step 301, where workflow management service 110 receives a request to register an additional new workflow document.

When workflow management service 110 determines that central account 120 does not have available capacity, workflow management service 110 identifies a shard account 130 or 140 with capacity for the new workflow document (step 307). The identified shard account 130, 140 may be proactively scaled up for allocation of workflow documents, as described above in relation to process 200. It is noted that as workflow documents are allocated to shard accounts 130, 140, some shard accounts may run out of capacity for additional new workflow documents (e.g., shard account 130 may have 1,000 workflow documents, equal the document limit of imposed by compute provider 180). Workflow management service 110 may proactively scale up new shard accounts 130, 140 (according to process 200) such that at least one shard account 130, 140 with free capacity is available for allocation of new workflow documents. If there are multiple shard accounts 130, 140 with available capacity, workflow management service 110 may select the shard account 130, 140 with the highest number of workflow documents (thus “filling up” an older shard account 130 before allocating workflow documents to a newer shard account 140).

Workflow management service 110 allocates the new workflow document to the identified shard account 130, 140 (step 309). Process 300 then returns to step 301, where workflow management service 110 receives a request to register an additional new workflow document.

FIG. 4 illustrates an operation sequence in the context of computing environment 100 in an implementation, represented by sequence 400. Sequence 400 includes workflow management service 110, central account 120, and shard account 130.

In sequence 400, central account 120 identifies that the number of workflow documents in central account 120 has exceeded a threshold (as discussed above in relation to step 205 of process 200), or transition point or indicator. Central account 120 provides an alert to workflow management service 110. In response to receiving the alert, workflow management service 110 provisions shard account 130. Provisioning shard account 130 may involve calling compute provider 180's APIs to register a new account ID and configure the necessary workflow execution services (e.g., services 143 of FIG. 1A). Provisioning shard account 130 may be performed manually by an administrator of workflow management service 110, or automatically via API calls to compute provider 180.

Central account 120 obtains a request from a customer to register a new workflow document (as discussed above in relation to step 301 of process 300). Central account 120 determines whether the central account 120 is at capacity (e.g. the central account is currently hosting 5,000 workflow documents where the document limit is 5,000). If central account 120 is at capacity, central account 120 allocates the new workflow document to shard account 130 and shard account 130 executes the new workflow document (as discussed above in relation to step 309 of process 300). If central account 120 is not at capacity, central account 120 hosts and executes the new workflow document. In either case, sequence 400 continues to obtain requests for new workflow documents and make allocation determinations based on capacity. Further, central account may provision an additional shard account when shard account 130 has a number of workflow documents exceeding an additional threshold (or transition point or indicator, or any boundary indicating that rebalancing among accounts is appropriate), as discussed above in relation to steps 207-211 of process 200).

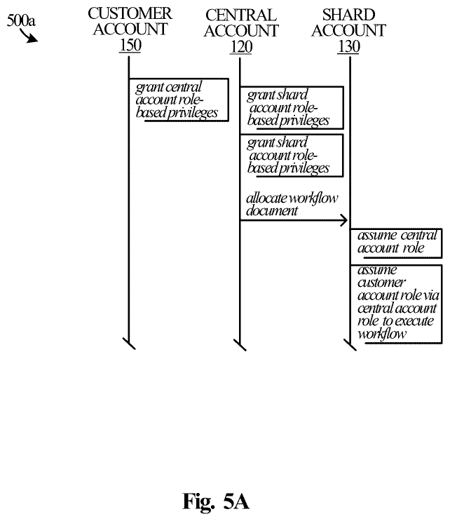

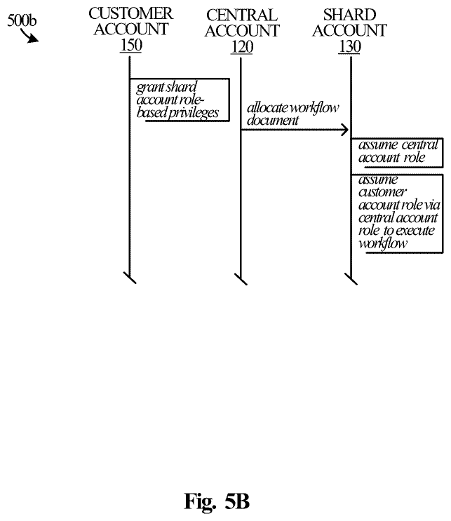

FIG. 5A illustrates an operation sequence in the context of compute environment 100 in an implementation, represented by sequence 500a. Sequence 500a includes customer account 150, central account 120, and shard account 130. Sequence 500 describes an implementation in which shard account 130 chains role-based privileges to execute workflow documents on behalf of customer account 150, as described above in relation to access manager 151 and access manager 125. This implementation simplifies customer onboarding, since customer account 150 only needs to grant privileges to central account 120. Shard account 130 does not have direct authorization from customer account 150. Instead, customer account 150 only grants execution privileges to central account 120, which then enables shard account 130 to assume a “central account role.”

This role-chaining mechanism allows shard account 130 to temporarily inherit the permissions necessary to execute workflow documents on behalf of customer account 150, without requiring direct configuration changes by the customer. Customer onboarding is simplified since customers are only required to establish a trust relationship with central account 120, rather than managing role assignments across shard accounts 130, 140. Additionally, because shard account 130 executes workflows under the assumed privileges of central account 120, execution remains transparent to customer account 150, meaning that operations performed by shard account 130 appear functionally indistinguishable from those executed directly by central account 120.

In sequence 500a, customer account 150 grants, to central account 120 a customer-account role granting privileges to execute workflow documents on behalf of customer account 150. Central account 120 grants, to shard account 130 a central-account role granting privileges to execute workflow documents on behalf of central account 120. Customer account 150 submits a workflow document request to central account 120. Central account 120 allocates the workflow document to shard account 130, as described above in relation to step 205. Shard account 130 assumes the central-account role, then assumes the customer-account role by chaining the central-account role to the customer-account role. Shard account 130 then executes the assigned workflow documents using the assumed privileges.

FIG. 5B illustrates an operation sequence in the context of compute environment 100 in an implementation, represented by sequence 500b. Sequence 500b includes customer account 150, central account 120, and shard account 130. Sequence 500 describes an implementation in which customer account 150 grants role-based privileges directly to shard account 130. This approach simplifies the execution of workflow documents at runtime. Unlike the role-chaining approach in sequence 500a, where shard accounts assume a central account role before executing customer workflows, this method eliminates the intermediate step and allows shard accounts to interact directly with customer accounts. By granting direct execution permissions, customer accounts reduce the number of role assumptions required for workflow execution, which may lower latency in the execution of workflow documents. Role-based privileges are a security mechanism that assigns permissions based on defined roles rather than individual user credentials. For example, an IAM role is a set of permissions that can be assumed by trusted entities, such as an account (e.g., central account 120 or shard accounts 130, 140), allowing them to perform specific actions on resources. This model supports secure cross-account interactions by enabling one account to temporarily assume a role in a second account to perform actions on behalf of the second account.

In sequence 500b, customer account 150 grants, to shard account 130, a customer-account role granting privileges to execute workflow documents on behalf of customer account 150. Central account 120 allocates a workflow document to shard account 130, as described above in relation to step 205. Shard account 130 assumes the customer account role and executes the workflow document on behalf of the customer account.

Accordingly, sequence 500b utilizes avoiding the multi-step role assumption process required of sequence 500a. The approach of sequence 500b may be utilized in environments where reducing execution overhead is a priority, while role chaining (as shown in sequence 500a) may be more in environments where shard accounts are frequently added (as granting permissions to multiple shard accounts may complicate customer-onboarding processes).

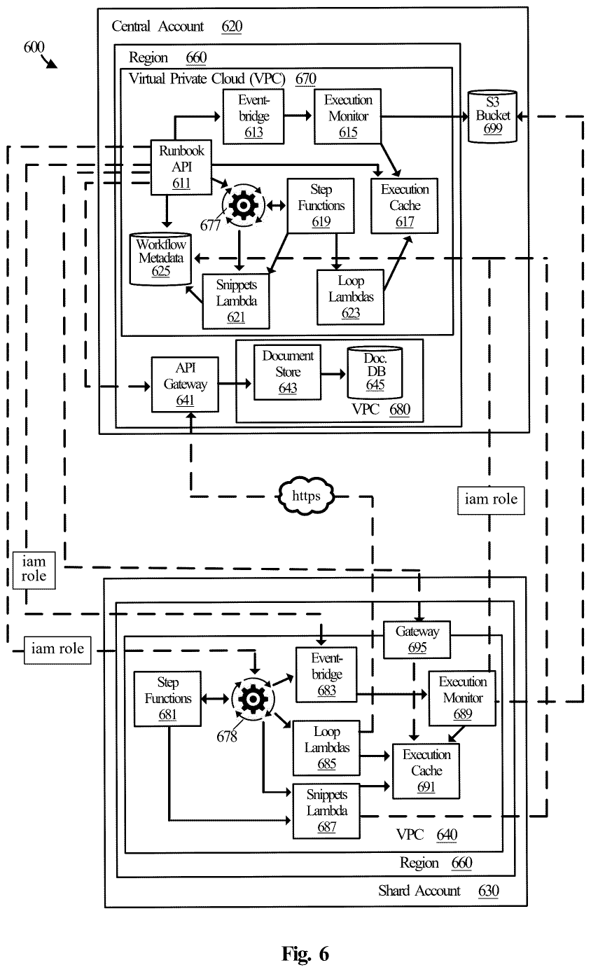

FIG. 6 illustrates compute environment 600a in an implementation. Compute environment 600a includes central account 620 and shard account 630.

Central account 620 represents an account with a compute provider (e.g., compute provider 180 of FIGS. 1A, 1B) hosting a backend platform for a workflow management service (e.g., workflow management service 110 of FIGS. 1A, 1B). FIG. 6 illustrates the operation of central account 620 within region 660, which may correspond to one of the regions of the compute provider (e.g., regions 170, 175, 190, or 195 described in FIG. 1B).

Central account 620 operates two virtual private clouds (VPCs): VPC 670 and VPC 680. A VPC is an isolated networking environment within a compute provider that allows for the secure deployment of resources such as compute instances, databases, and storage services. A VPC provides controlled access, security configurations, and network segmentation. Various workflow execution services can be deployed in VPCs, as discussed in greater detail below with respect to VPC 670 and VPC 680.

VPC 670 serves as the execution and distribution environment for hosting and executing workflow documents, as well as facilitating workflow orchestration and distribution. VPC 670 hosts several services illustrated in FIG. 6, each of which is discussed in turn below.

Runbook API 611 is a service that handles incoming workflow document requests and distributes these documents among accounts. Customers or administrators of the workflow management service can submit requests to add a workflow document via a call to Runbook API 611. Upon receiving such a request, Runbook API 611 first determines which account should be allocated the workflow document by querying workflow metadata 625. Workflow metadata 625 stores metadata that details where each workflow document is allocated (e.g., central account 620, shard account 630, or another shard account in computing environment 600). Runbook API 611 uses this metadata to determine the number of workflow documents currently allocated to central account 620. If this number is below the document limit imposed by the compute provider (e.g., 5,000), Runbook API 611 allocates the workflow document to central account 620 by forwarding the request to automation engine 677, which processes the request as discussed further below.

If the number of workflow documents in central account 620 has reached capacity (i.e., equal to the document limit imposed by the compute provider, such as 5,000), Runbook API 611 allocates the workflow document to shard account 630 (or another shard account in compute environment 600). Runbook API 611 may select shard account 630 by querying Workflow metadata 625, which maps each shard account to a particular customer. Thus, if the customer who submitted the workflow document request is associated with shard account 630, Runbook API 611 sends the request to execution monitor 689 within shard account 630. To send the request, Runbook API 611 assumes a shard-account role (represented by the “IAM role” connection in FIG. 6) to forward the request to execution monitor 689 of shard account 630. Accordingly, compute environment 600 illustrates an implementation in which each shard account is associated with a particular customer. However, in other implementations, shard accounts may host workflow documents for multiple customers, as described further below in relation to compute environment 1000.

An “IAM role” is a security identity defined with a specific set of permissions and trust relationships that enable a service in one account (e.g., shard account 630) to access resources in another account (e.g., central account 620). In this context, when Runbook API 611 allocates a workflow document to a shard account, it assumes a shard-account IAM Role. The IAM role provides Runbook API 611 with temporary credentials and the necessary permissions to invoke services (i.e., automation engine 678 and eventbridge 683) in shard account 630. An administrator of the workflow management service may configure these permissions by creating a detailed policy that explicitly defines allowed actions and specifies which accounts or services are trusted to assume the role.

Upon allocating a workflow document to either central account 620 or shard account 630, Runbook API updates workflow metadata 625 to indicate which account the workflow document is allocated to, and which customer is associated with the document (as shown by way of example in Table 2 above). Thus, Runbook API maintains “sharding metadata” (i.e., metadata indicating the associated account for each workflow document) in workflow metadata 625.

Runbook API 611 further interacts with execution cache 617 to provide real-time visibility into workflow execution in central account 620. As workflows run in central account, data such as execution logs, state updates, and progress indicators are pushed into execution cache 617. When a user requests the current status of a workflow, Runbook API 611 accesses execution cache 617 to pull the most recent execution data.

Similarly, for workflows running in shard account 630, execution data is collected in Execution cache 691. However, because this cache resides in a different account, Runbook API 611 accesses execution cache 691 via gateway 695.

Accordingly, Runbook API 611 is further configured to allow customers to view execution details of workflow document execution for both central account 620 and shard account 630. To support this functionality, gateway 695 is deployed as a secure network component that enables the Runbook API 611 to securely access execution output stored in the execution cache 691 of shard account 630. Gateway 695 is designed to provide a secure connection between central account 620 and shard account 630. When a user submits a request to view workflow execution data, Runbook API 611 first queries workflow metadata to determine where the associated workflow document resides. Where the workflow document is hosted by central account 630, Runbook API retrieves the execution data from execution cache 617 and provides it to the user. Where the workflow document is hosted by shard account 630, Runbook API retrieves the execution data from execution cache 691 via gateway 695.

Gateway 695 functions as a dedicated network conduit that enables secure, low-latency connectivity between the central account 620 and shard account 630. Gateway 695 routes traffic directly between Runbook API 611 and execution cache 691 of shard account 630. Gateway 695 is configured with access control policies to prevent unauthorized access while minimizing the additional hops and processing delays typically associated with cross-account communications. Gateway 695 may incorporate Web Application Firewall (WAF), an authentication layer (verifying the identity of incoming requests), and a REST API Lambda function that acts as a proxy to execution cache 691 (forwarding authorized requests to the execution cache 691).

Runbook API 611 further includes a “Shard Rebalancer” function that continuously monitors the number of workflow documents stored in each shard account. When a shard account (e.g., shard account 630) nears its document limit (e.g., when it reaches 800 out of a 1,000 document limit) Runbook API 611 issues an alert to an administrator of the workflow management service. Upon receiving this alert, the administrator can initiate a migration process to move a customer's workflows and associated execution data from the nearly full shard account to a new shard account.

Alternatively, the alert may trigger an automated system that provisions a new shard account and handles the migration. This migration process involves configuring the new shard account with the necessary execution services (such as Loop Lambda and Snippets Lambda) and updating the relevant metadata in workflow metadata 625. Furthermore, if a customer who initially onboarded with a specific shard account (e.g., shard account 630) is later a to a different shard account, Runbook API 611 provides a notification to the customer, prompting them to update their target account IAM role to trust the new shard account. Runbook API 611 may begin allocating new workflow documents to the new shard account once the migration is complete. Alternatively, Runbook API 611 may continue to allocate new workflow documents to the initial shard account 630 until shard account 630 reaches capacity (e.g., 1,000 out of 1,000 workflow documents), at which point Runbook API allocates new workflow documents to the new shard account.

Automation engine 677 represents a service configured to store workflow documents and manage the execution of workflow documents. In one implementation, automation engine 677 is implemented using AWS Systems Manager (SSM) Automation. When Runbook API 611 submits a request to add a new workflow document, automation engine 677 first validates the document to check if the defined sequence of actions meets the required syntax and operational standards. Upon validation, the workflow document is then stored in a repository within automation engine 677. The compute provider (e.g., compute provider 180 of FIGS. 1A, 1B) imposes a document limit (e.g., 5,000) on the number of workflow documents that may be stored in the repository of automation engine 677.

Snippets Lambda 621, in addition to executing discrete operations, is configured to updates workflow metadata 625. Upon completing its tasks (e.g., performing a data transformation or interfacing with an external API) Snippets Lambda 621 sends detailed updates, including success status, output results, and any errors, directly to the workflow metadata 625.

Once a workflow document is added, automation engine 677 manages its execution by orchestrating each pre-defined step in the workflow document. The workflow document, typically defined in a structured format like JSON or YAML, outlines a sequence of tasks that may involve invoking various modular components. For example, when a workflow requires iterative processing, automation engine 677 interfaces with step functions 619, which manages repetitive tasks executed by Loop Lambdas 623. If a step calls for a small, self-contained piece of logic, the automation engine 677 routes that portion to Snippets Lambda 621, to handle execution of the logic.

Furthermore, for workflows that involve state transitions, automation engine 677 integrates with step function 619. Step function 619 is responsible for managing state transitions, handling dependencies between steps, and providing that each stage of the workflow document is executed in order.

EventBridge 613 is representative of a service that detects and triggers the execution of workflow documents based on predefined events or schedules. Serving as a hub for monitoring and responding to various triggers, EventBridge 613 can detect external requests to execute a workflow (received via Runbook API 611) or scheduled time-based events. EventBridge 613 operates according to rules that match specific event patterns. When these patterns are detected, EventBridge 613 routes the corresponding events to Step Functions 619, Loop Lambdas 623, or automation engine 677 for further processing, providing that each workflow document is initiated by the correct component at the right time.

Snippets Lambda 621 is representative of a service executing concise, self-contained pieces of logic (e.g., data transformation or interfacing with external APIs) in a workflow document. Snippets Lambda 621 is invoked by the automation engine 677 as part of the execution processes of a workflow document. This invocation may include passing, from automation engine 677 execution parameters and contextual data defined in the workflow document. Snippets Lambda 621 includes pre-packaged code reflecting discrete steps defined in the workflow, which may be executed utilizing the parameters passed by automation engine 677.

Step Functions 619 represents a service that orchestrates iterative processing within workflows by managing looping tasks. In scenarios where Automation Engine 677 lacks native looping support, automation engine 677 invokes step functions 619 to manage looping actions in workflow documents. Step functions 619 receive execution parameters and contextual data from automation engine 677, then directs the execution of Loop Lambdas 623. In addition, Step Functions 619 may also interact with Snippets Lambda 621 to handle discrete, self-contained operations that may be required within the same workflow document that includes a looping function. For example, a workflow document might perform a discrete task handled by Snippets Lambda 621 before continuing with iterative processing handled by Loop Lambdas 623.

Loop Lambdas 623 represents a service for handling iterative processing by executing looping tasks until a specified condition is met. Functions of loop lambdas 623 include pre-packaged code that reflects the discrete, repetitive steps outlined in the workflow document. Step functions 619 orchestrates the invocation of Loop Lambdas 623 by passing the necessary execution parameters and contextual data for Loop Lambdas 623 to perform the looping operations.

Execution cache 617 represents an in-memory data store (such as a Redis cache) that holds data generated during the execution of workflow documents. Execution cache 617 stores information such as execution logs, state transitions, progress indicators, error messages, and intermediate results received from execution monitor 615, Loop Lambdas 623, and Snippets Lambda 621. Runbook API 611 can query execution cache 617 and retrieve the latest execution details, as described above.

Execution monitor 615 represents a service that tracks and aggregates real-time data from executing workflow documents. Execution monitor 615 collects logs, state transitions, and error messages from various components (step functions 619, Loop Lambdas 623, and Snippets Lambda 621) and stores this data in S3 bucket 699, for audit and analysis purposes.

S3 Bucket 699 represents a persistent data store that securely archives critical workflow execution data. S3 bucket 699 stores data collected from Execution Monitor 615 in the central account as well as similar data from Execution Monitor 689 in shard account 630. In addition to its primary role as a long-term repository for historical records used in auditing, debugging, and compliance, S3 Bucket 699 also functions as an overflow repository. For instance, when the capacity of transient stores like execution cache 617 is exceeded, additional execution data is stored in S3 Bucket 699, ensuring that no critical information is lost.

VPC 680 represents a networking environment within the central account 620. VPC is designed to securely host critical data storage services and ensure that sensitive workflow-related information is segregated from other operational workloads. VPC 680 includes document store 643 and document database 645.

Document Store 643 represents a service that encapsulates the logic for storing workflow documents and related artifacts, such as workflow document definitions. Document store 643 is responsible for processing and managing data before committing it to document database 645, providing secure storage within VPC 680 of Central Account 620.

Document database 845 represents persistent storage within VPC 680 of Central Account 620, for long-term storage and retrieval of workflow document metadata and artifacts, such as workflow document definitions and configurations. Document DB 845 is managed by document store 842, providing secure handling of this data within the workflow management service.

Shard account 630 represents another account with a compute provider operated by the workflow management service (e.g. workflow management service 110 of FIGS. 1A, 1B). Shard account 620 may host and execute workflows allocated by central account 620. In some implementations, shard account 620 may be associated with a particular customer of the workflow management service. Accordingly, computing environment 600 may include multiple shard accounts similar to shard account 630, with each of the shard accounts being associated with a customer. However, in other implementations, shard accounts might not be customer-specific, as described below in relation to computing environment 1000. Shard account 630 operates VPC 640 in region 660 (i.e., the same region of VPC 670 of central account 620.

VPC 640 includes several services for hosting and executing workflow documents allocated to shard account 630 by central account 620.

Automation engine 678 is representative of a service for storing and managing the execution of workflow documents allocated to shard account 630 by central account 620. Automation engine 678 may be substantially similar to automation engine 677 of central account 620. When Runbook API 611 submits a request to automation engine 678 to add a new workflow document to shard account 630, automation engine 678 first validates the workflow document to check if the defined sequence of actions meets the required syntax and operational standards. Upon validation, the workflow document is then stored in a repository within automation engine 678. The compute provider (e.g., compute provider 180 of FIGS. 1A, 1B) imposes a document limit (e.g., 1,000) on the number of workflow documents that may be stored in the repository of automation engine 677 of shard account 630.

Shard account 630 is provisioned with a full suite of execution services allowing workflow documents to be fully and independently executed by shard account 630 (referred to as the full-isolation model, meaning that shard account 630 does not rely on central account 620 for workflow execution. In particular, shard account 630 includes step functions 681 (which may operate in a substantially similar manner to step functions 619 of central account 620 described above), Loop Lambdas 685 (which may operate in a substantially similar manner to Loop Lambdas 623 of central account 620 described above) Snippets Lambda 687 (which may operate in a substantially similar manner to Snippets Lambda 621 of central account 620 described above), execution cache 691 (which may operate in a substantially similar manner to execution cache 617 of central account 620 described above) and execution monitor 689 (which may operate in a substantially similar manner to execution monitor 615 of central account 620 described above).

Loop Lambdas 685 may interface with API Gateway 641 via an HTTPS connection to query Document Store 643 for workflow documents and configuration data pertinent to their looping operations. Document store 643 acts as an intermediary that retrieves the requested information from Document database 645 and returns it through API Gateway 641 to Loop Lambdas 685.

Execution monitor 689 is configured to assume a central account role (via an IAM role) that grants it permissions to update workflow metadata 625 based on the logs, state transitions, and error messages generated by workflow documents executing in shard account 630. Additionally, execution monitor 689 stores this collected data in S3 Bucket 699, providing that persistent records of workflow execution in shard account 630 are maintained for auditing, troubleshooting, and long-term analysis purposes.

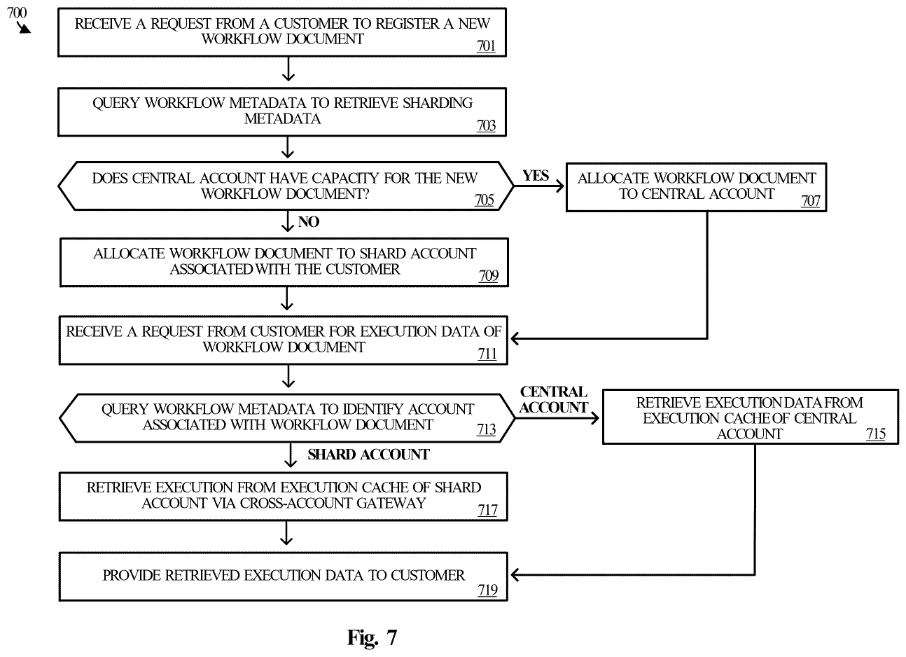

FIG. 7 illustrates a resource management process performed by a workflow management service, represented by process 700. Process 700 is employed by a computing device to provide resource management, an example of which is provided by computing system 1201 of FIG. 12. Process 700 may be implemented in program instructions (software and/or firmware) by one or more processors of the computing device. The program instructions direct the computing device to operate as follows, referring parenthetically to the steps in FIG. 7.

Runbook API 611 receives a request to register a new workflow document for a customer (step 701). Runbook API 611 receives a request, for example, when a customer requests a new service from workflow management service 110 via an API call to Runbook API 611. For example, Runbook API 611 may receive a request to register a rightsizing workflow document in central account 620 for execution on behalf of the customer.

Runbook API 611 queries workflow metadata 625 to retrieve sharding metadata (step 703). This metadata identifies the accounts associated with each workflow document. Based on this metadata Runbook API 611 determines the total number of workflow documents allocated to central account 620.

Runbook API 611 determines if central account 620 has capacity to host the new workflow document (step 705). This determination is based on the number of workflow documents allocated to central account 620 identified in step 703. If the number of workflow documents in central account 620 equal to the compute provider limit (e.g., 5,000), central account 620 does not have capacity for hosting the new workflow document, and process 700 proceeds to step 709. If the number of workflow documents in central account is less than the document limit (e.g., 2,000, 4,000, 4,999, etc.), workflow management service 110 determines that central account 620 has available capacity, and process 700 proceeds to step 707.

When it is determined that central account 620 has available capacity for new workflow documents, workflow management service 110 allocates the new workflow document to central account 620 (step 707). Allocating the workflow document to central account 620 may include submitting a call to workflow automation engine 677 to add the workflow document to automation engine 677. Process 700 then proceeds to step 711, where Runbook API 611 receives a request from a customer to view execution data for the workflow document.

When it is determined that central account 620 does not have available capacity, Runbook API 611 allocates the workflow document to shard account 630 associated with the customer (step 709). Allocating the workflow document to shard account 630 may include assuming, by Runbook API 611, a shard-account role to provide a call to automation engine 678 of shard account 630 to add the workflow document to automation engine 678. Runbook API 611 may also assume the shard account-role to configure eventbridge 683 with parameters related to the workflow document, such as triggering conditions for steps in the workflow document.

Runbook API 611 receives a request from a customer to view execution metadata for a workflow document (step 711). For instance, a customer may submit a request to Runbook API 611 to retrieve the status of a workflow document, including details such as completed steps, current progress, error messages, and any associated logs.

Runbook API 611 queries workflow metadata 625 to determine which account is associated with the workflow document. Based on the workflow metadata, Runbook API 611 determines that the workflow document is allocated to one of: central account 620, shard account 630, or another shard account in compute environment 600 (step 713).

If the workflow document is allocated to central account 620, Runbook API 611 retrieves execution data from execution cache 617 (step 715). This execution data may include the status of the workflow document, including, for example, completed steps, error messages or any logs generated during workflow execution. If the workflow document is allocated to shard account 630, Runbook API retrieves the execution data from execution cache 691 via a cross-account gateway 695 (step 717). By querying execution cache 617 for execution data in central account 620 and execution cache 691 for execution data in shard account 630, Runbook API 611 may obtain the real-time (up-to-date) status of the workflow document. It is noted that data from execution caches 617 and 691 may eventually be uploaded to workflow metadata 625 (which may be a global database such as DynamoDB) for persistent storage. However, these updates are typically performed at scheduled intervals or upon certain events, meaning that workflow metadata 625 may not always reflect the most up-to-date execution status. Accordingly, Runbook API 611 obtains up-to-date data by querying execution cache 617 and execution cache 691.

After retrieving the execution data from the appropriate execution cache (e.g., execution cache 617 or execution cache 691), Runbook API 611 provides the retrieved data to the requesting customer (step 719). By querying up-to-date, memory-based execution caches 617, 691, Runbook API 611 enables near real-time visibility into ongoing workflow executions, facilitating prompt decision-making, troubleshooting, or further automation.

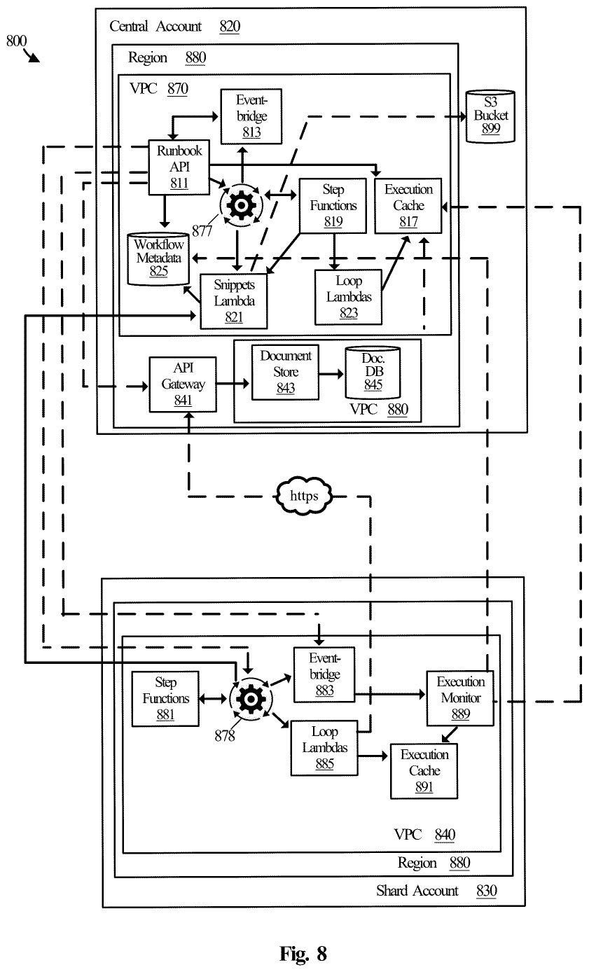

FIG. 8 illustrates computing environment 800 in an implementation. Computing environment 800 includes central account 820 and shard account 830. FIG. 8 illustrates an arrangement in which shard account 830 utilizes some execution services of central account 820 (e.g., Snippets Lambda 821) and some execution services within shard account 830 itself (e.g., Loop Lambdas 885). This arrangement, in which part of execution for workflow documents in shard account 830 is performed in central account 820, is referred to as semi-isolation.

Central account 820 represents an account with a compute provider (e.g., compute provider 180 of FIGS. 1A, 1B) hosting a backend platform for a workflow management service (e.g., workflow management service 110 of FIGS. 1A, 1B). FIG. 8 illustrates the operation of central account 820 within region 880, which may correspond to one of the regions of the compute provider (e.g., regions 170, 175, 190, or 195 described in FIG. 1B).

VPC 870 serves as the execution and distribution environment for hosting and executing workflow documents, as well as facilitating workflow orchestration and distribution. VPC 870 hosts several services illustrated in FIG. 8, each of which is discussed in turn below.

Runbook API 811 is representative of a service receiving user requests, performing shard rebalancing functions, and allocating workflow documents. Runbook API 811 is substantially similar to Runbook API 611 described above with respect to FIG. 6.

Workflow metadata 825 is representative of a data store maintaining metadata for workflow documents hosted by central account 820 and shard account 830. Workflow metadata may be substantially similar to workflow metadata 825 described above with respect to FIG. 6.

Automation engine 877 is representative of a service that stores and executes workflow documents. Automation engine 877 may be substantially similar to automation engine 677 of FIG. 6.

Loop Lambdas 823 is representative of a service for executing iterative or looping actions of workflow documents. Loop Lambdas may be substantially similar to Loop Lambdas 623 of FIG. 6.

Execution cache 817 is representative of a memory store maintain real-time or near real-time execution data. Execution cache is substantially similar to execution cache 617 described above with respect to FIG. 6.

Eventbridge 813 is representative of a service identifying conditions for triggering workflow documents. Eventbridge 813 is substantially similar to eventbridge 613 described above with respect to FIG. 6.

Snippets Lambda 821 is representative of a service designed to execute discrete or isolated tasks within workflow documents. Snippets Lambda 821 may be substantially similar to Snippets Lambda 621 of FIG. 6. However, in the embodiment illustrated in FIG. 8, Snippets Lambda 821 can be invoked by both Automation Engine 877 of central account 820 and Automation Engine 878 of shard account 830. This enables Snippets Lambda 821 to handle targeted tasks (e.g., data transformations, external API calls, or other specialized operations) across multiple accounts, without separate deployments of Snippets Lambda in each account.

VPC 880 represents a networking environment within the central account 820. VPC is substantially similar to VPC 680 of FIG. 6.

Document Store 843 represents a service that encapsulates the logic for storing workflow documents and related artifacts, such as workflow document definitions. Document store 843 is substantially similar to document store 643 of FIG. 6.

Document database 845 represents persistent storage within VPC 880 of Central Account 820, for long-term storage and retrieval of workflow document metadata and artifacts, such as workflow document definitions and configurations. Document database 845 is substantially similar to document database 645 of FIG. 6.

Shard account 830 represents another account with a compute provider operated by the workflow management service (e.g. workflow management service 110 of FIGS. 1A, 1B). Shard account 830 may host and execute workflows allocated by central account 820. In some implementations, shard account 830 may be associated with a particular customer of the workflow management service. Accordingly, computing environment 800 may include multiple shard accounts similar to shard account 830, with each of the shard accounts being associated with a customer.

VPC 840 includes several services for hosting and executing workflow documents allocated to shard account 830 by central account 820.

Automation engine 878 is representative of a service for storing and managing the execution of workflow documents allocated to shard account 830 by central account 820. Automation engine 878 may be substantially similar to automation engine 678 of FIG. 6. However, in contrast to the implementation of FIG. 6, automation engine 878 of FIG. 8 may invoke Snippets Lambda 821 of central account 820. Accordingly, shard account 830 does not include a Snippets Lambda function, as shard account 830 relies on central account to perform Snippets Lambda operations. This arrangement (referred to as the “semi-isolation” approach) simplifies the configuration of shard account 830.

When Automation Engine 878 in shard account 630 processes a workflow document, Automation Engine 878 determines the appropriate task type based on the defined steps of the workflow document. For discrete or self-contained tasks, Automation Engine 878 invokes Snippets Lambda 821 in central account 820, passing along execution parameters. For iterative or repetitive tasks, Automation Engine 878 invokes the local Loop Lambdas 885 of shard account 830.

Loop Lambdas 885 handle looping or iterative processes for workflow documents in shard account 830. Loop Lambdas 885 may be substantially similar to Loop Lambdas 685 of FIG. 6.

Execution Monitor 689 is configured to monitor execution of workflow documents in shard account 830. Execution Monitor 889 is substantially similar to Execution Monitor 689 of FIG. 6.

Execution cache 891 stores execution related data, and may be substantially similar to execution cache 691 of FIG. 6.

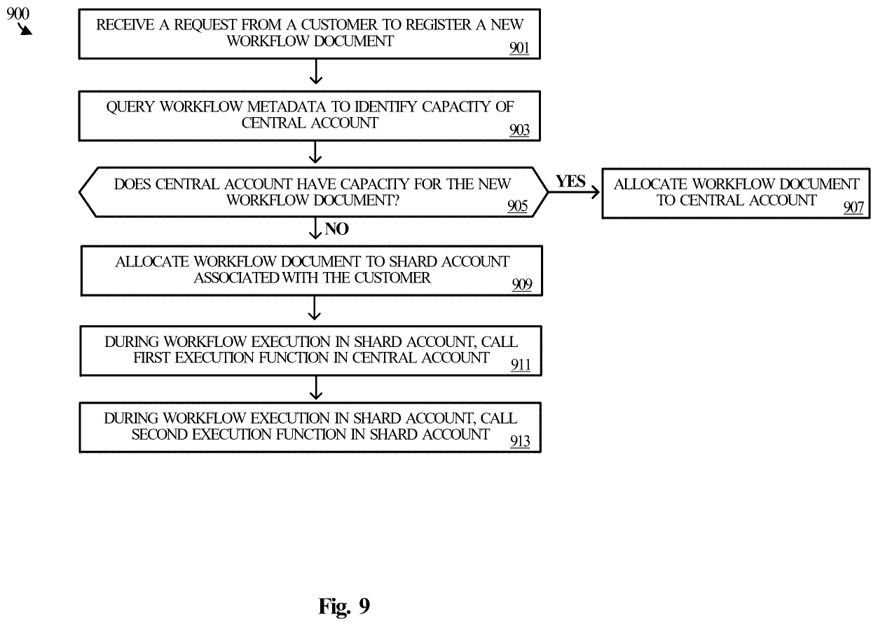

FIG. 9 illustrates a resource management process performed by a workflow management service, represented by process 900. Process 900 is employed by a computing device to provide resource management, an example of which is provided by computing system 1201 of FIG. 12. Process 900 may be implemented in program instructions (software and/or firmware) by one or more processors of the computing device. The program instructions direct the computing device to operate as follows, referring parenthetically to the steps in FIG. 9.

Runbook API 811 receives a request to register a new workflow document for a customer (step 901). Runbook API 811 receives a request, for example, when the customer requests a new service from the workflow management service via an API call to Runbook API 811. For example, Runbook API 811 may receive a request to register a rightsizing workflow document in central account 120 for execution on behalf of the customer.

Runbook API 811 queries workflow metadata 825 to retrieve sharding metadata (step 903). This metadata identifies the accounts associated with each workflow document. Based on this metadata Runbook API 811 determines the total number of workflow documents allocated to central account 820.

Runbook API 811 determines if central account 810 has capacity to host the new workflow document (step 905). This determination is based on the number of workflow documents allocated to central account 820 identified in step 903. If the number of workflow documents in central account 820 equal to the compute provider limit (e.g., 5,000), central account 820 does not have capacity for hosting the new workflow document, and process 900 proceeds to step 909. If the number of workflow documents in central account 820 is less than the document limit (e.g., 2,000, 4,000, 4,999, etc.), workflow management service 110 determines that central account 820 has available capacity, and process 900 proceeds to step 907.

When it is determined that central account 820 has available capacity for new workflow documents, workflow management service 110 allocates the new workflow document to central account 820 (step 907). Allocating the workflow document to central account 820 may include submitting a call to workflow automation engine 877 to add the workflow document to automation engine 877. Process 900 then proceeds to step 911, where Runbook API 811 receives a request from a customer to view execution data for the workflow document.

When it is determined that central account 820 does not have available capacity, Runbook API 811 allocates the workflow document to shard account 830 associated with the customer (step 909). Allocating the workflow document to shard account 830 may include assuming, by Runbook API 811, a shard-account role to provide a call to automation engine 878 of shard account 830 to add the workflow document to automation engine 878. Runbook API 811 may also assume the shard account-role to configure event bridge 883 with parameters related to the workflow document, such as triggering conditions for steps in the workflow document.

During execution of the workflow document in shard account 830, automation engine 878 calls a first execution function in shard account 830 (step 911). The first execution function may be a looping function called for by the workflow documents performed by Loop Lambdas 885.

Further, during execution of the workflow document in shard account 830, automation engine 878 calls a second execution function in central account 820 (step 913). The second execution function may be a discrete, self-contained task performed by Snippets Lambda 821 of central account 820. Here, a discrete task may refer to a step or a series of steps without looping or iteration. Discrete tasks are configured to perform a specific function, such as transforming data or interfacing with an external API, without relying on prior or subsequent operations for context. By delegating such discrete tasks to central account 820, the system benefits from centralized and consistent logic execution and logging, thereby simplifying debugging and maintenance. The delegation of self-contained tasks to central account 820 provides that the system centralizes discrete tasks that benefit from consistent, unified logic and logging.

Accordingly, steps 911 and 913 illustrate that Automation Engine 878 in shard account 830 leverages a hybrid (semi-isolation) execution model by utilizing services from both its local environment (namely Loop Lambdas 885 for iterative tasks) and from central account 820 (namely Snippets Lambda 821 for discrete tasks).

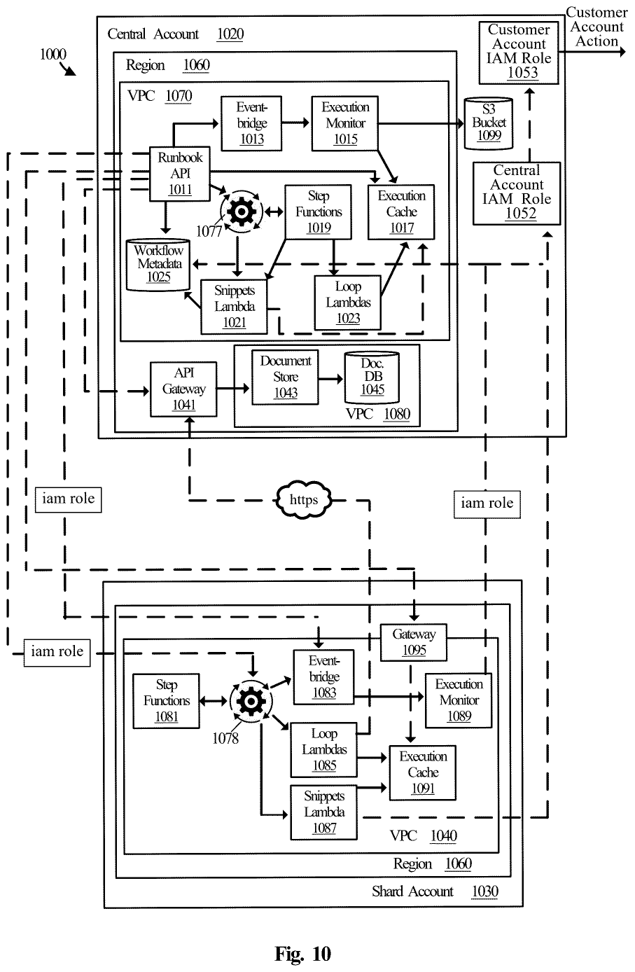

FIG. 10 illustrates compute environment 1000 in an implementation. Compute environment 100 includes central account 1020 and shard account 1030. Compute environment 1000 is similar to compute environment 600 described above, except that shard account 1030 is not customer specific, as described further below (whereas shard account 630 described above in relation to FIG. 6 is specific to a customer). Further, shard account 1030 in computing environment 1000 utilizes role-chaining to perform actions for customer accounts, as described further below.

Central account 1020 represents an account with a compute provider (e.g., compute provider 180 of FIGS. 1A, 1B) hosting a backend platform for a workflow management service (e.g., workflow management service 110 of FIGS. 1A, 1B). FIG. 10 illustrates the operation of central account 1020 within region 1060, which may correspond to one of the regions of the compute provider (e.g., regions 170, 175, 190, or 195 described in FIG. 1B).

Central account 1020 operates two virtual private clouds (VPCs): VPC 1070 and VPC 1080. VPC 1070 serves as the execution and distribution environment for hosting and executing workflow documents, as well as facilitating workflow orchestration and distribution. VPC 1070 hosts several services illustrated in FIG. 10, each of which is discussed in turn below.

Runbook API 1011 is a service that handles incoming workflow document requests and distributes these documents among accounts. Runbook API 1011 may be substantially similar to Runbook API 611 described above in FIG. 6, except that in computing environment 1000, shard accounts are not associated with particular customers. Rather shard accounts (e.g., shard account 1030) may host and execute workflow documents on behalf of several different customers. Accordingly, Runbook API 1011 allocates workflow documents from multiple different customers to the same shard account 1030.

Runbook API 1011 includes a “Shard Rebalancer” function that continuously monitors the number of workflow documents stored in shard account 1030. When shard account 1030 nears its document limit (e.g., when it reaches 800 out of a 1,000-document limit) Runbook API 1011 issues an alert to an administrator of the workflow management service. Upon receiving this alert, the administrator can initiate a migration process to provision a new shard account to host workflows from multiple customers. Alternatively, the alert may trigger an automated system that provisions a new shard account and handles the migration. This migration process involves configuring the new shard account with the necessary execution services (such as Loop Lambda and Snippets Lambda) and updating the relevant metadata in workflow metadata 1025. Since shard account 1030 utilizes role-chaining, as described further below, customers do not need to reconfigure permissions when a new shard account is provisioned.

Workflow metadata 1025 is representative of a data store maintaining metadata for workflow documents hosted by central account 1020 and shard account 1030. Workflow metadata may be substantially similar to workflow metadata 625 described above with respect to FIG. 6.

Automation engine 1077 is representative of a service that stores and executes workflow documents. Automation engine 1077 may be substantially similar to automation engine 677 of FIG. 6.

Loop Lambdas 1023 is representative of a service for executing iterative or looping actions of workflow documents. Loop Lambdas may be substantially similar to Loop Lambdas 623 of FIG. 6.

Execution cache 1017 is representative of a memory store maintain real-time or near real-time execution data. Execution cache is substantially similar to execution cache 617 described above with respect to FIG. 6.

Execution monitor 1015 represents a service that tracks and aggregates real-time data from executing workflow documents. Execution monitor 1015 may be substantially similar to execution monitory 615 described in FIG. 6 above.

Step functions 1019 represents a service that orchestrates iterative processing within workflows by managing looping tasks. Step functions 1019 may be substantially similar to step functions 619 described in FIG. 6 above.

Eventbridge 1013 is representative of a service identifying conditions for triggering workflow documents. Eventbridge 1013 is substantially similar to eventbridge 613 described above with respect to FIG. 6.

Snippets Lambda 1021 is representative of a service designed to execute discrete or isolated tasks within workflow documents. Snippets Lambda 1021 may be substantially similar to Snippets Lambda 621 of FIG. 6. However, in the embodiment illustrated in FIG. 10, Snippets Lambda 1021 can be invoked by both Automation Engine 1077 of central account 1020 and Automation Engine 1078 of shard account 1030. This enables Snippets Lambda 1021 to handle targeted tasks (e.g., data transformations, external API calls, or other specialized operations) across multiple accounts, without separate deployments of Snippets Lambda in each account.

VPC 1080 represents a networking environment within the central account 1020. VPC is substantially similar to VPC 680 of FIG. 6.

Document Store 1043 represents a service that encapsulates the logic for storing workflow documents and related artifacts, such as workflow document definitions. Document store 1043 is substantially similar to document store 643 of FIG. 6. Document store 1043 is accessed via API gateway 1041, which may be substantially similar to API gateway 641 of FIG. 6.

Document database 1045 represents persistent storage within VPC 1080 of Central Account 1020, for long-term storage and retrieval of workflow document metadata and artifacts, such as workflow document definitions and configurations. Document database 1045 is substantially similar to document database 645 of FIG. 6.

Shard account 1030 represents another account with a compute provider operated by the workflow management service (e.g. workflow management service 110 of FIGS. 1A, 1B). Shard account 1030 may host and execute workflows allocated by central account 1020. In some implementations, shard account 1030 may be associated with a particular customer of the workflow management service. Accordingly, computing environment 1000 may include multiple shard accounts similar to shard account 1030, with each of the shard accounts being associated with a customer.

VPC 1040 includes several services for hosting and executing workflow documents allocated to shard account 1030 by central account 1020.

Automation engine 1078 is representative of a service for storing and managing the execution of workflow documents allocated to shard account 630 by central account 620. Automation engine 1078 may be substantially similar to automation engine 678 of FIG. 6. However, in contrast to the implementation of FIG. 6, automation engine 1078 of FIG. 10 may invoke Snippets Lambda 1021 of central account 1020. Accordingly, shard account 1030 does not include a Snippets Lambda function, as shard account 1030 relies on central account to perform Snippets Lambda operations. This arrangement (referred to as the “semi-isolation” approach) simplifies the configuration of shard account 1030.

When Automation Engine 1078 in shard account 630 processes a workflow document, it determines the appropriate task type based on the defined steps of the workflow document. For discrete or self-contained tasks, Automation Engine 1078 invokes Snippets Lambda 1021 in central account 1020, passing along execution parameters. For iterative or repetitive tasks, Automation Engine 1078 invokes the local Loop Lambdas 1085 of shard account 1030.

Loop Lambdas 1085 handle looping or iterative processes for workflow documents in shard account 1030. Loop Lambdas 1085 may be substantially similar to Loop Lambdas 685 of FIG. 6.

Execution Monitor 1089 is configured to monitor execution of workflow documents in shard account 1030. Execution monitory 1089 is substantially similar to execution monitory 689 of FIG. 6.

Execution cache 1091 stores execution related data, and may be substantially similar to execution cache 691 of FIG. 6.

Gateway 1095 is representative of an interface allowing Runbook API 1011 to query execution cache 1091. Gateway 1095 is substantially similar to gateway 695 of FIG. 6.

Snippets Lambda 1087 represents a service for executing discrete tasks for workflow documents in shard account 1030. Snippets Lambda 1087 is substantially similar to Snippets Lambda 687 of FIG. 6 above.

Step functions 1081 represents a service for coordinating with automation engine 1078 to manage execution of loops lambda 1085 and Snippets Lambda 1087. Step functions 1081 may be substantially similar to step functions 681 of FIG. 6.

Snippets Lambda 1087 utilizes role chaining to securely perform actions on behalf of customers, as illustrated in FIG. 10. First, Snippets Lambda 1087 assumes central account role 1052. Snippets Lambda 1087 uses the central-account role to assume the customer account role 1053. By chaining into the customer target alias, Snippets Lambda 1087 can provision resources or retrieve data in the customer's account (e.g., customer accounts 150, 160 of FIG. 1) This arrangement provides that customers may configure permissions only for central account 1020, without needing to update permissions when new shard accounts are brought online.

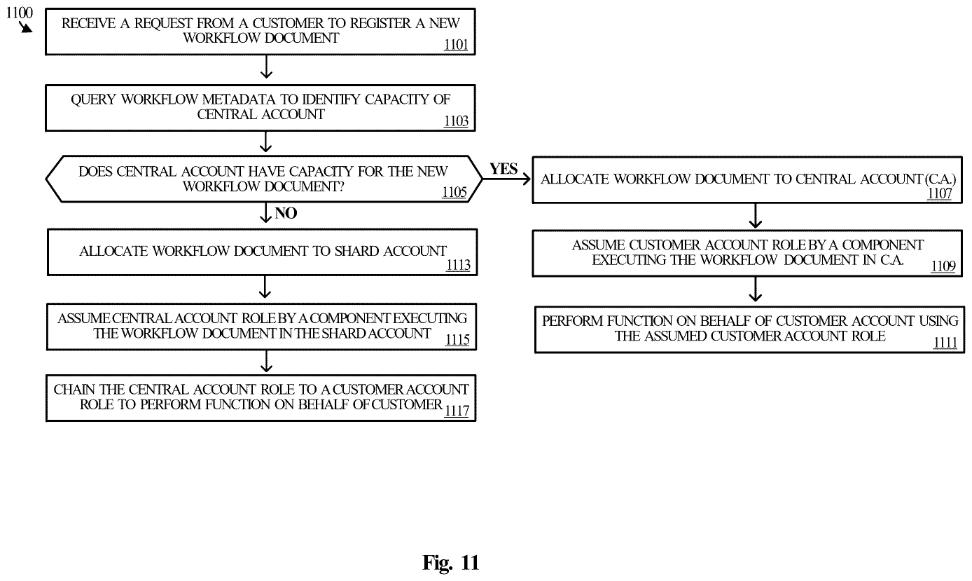

FIG. 11 illustrates a resource management process performed by a workflow management service, represented by process 1100. Process 1100 is employed by a computing device to provide resource management, an example of which is provided by computing system 1201 of FIG. 12. Process 1100 may be implemented in program instructions (software and/or firmware) by one or more processors of the computing device. The program instructions direct the computing device to operate as follows, referring parenthetically to the steps in FIG. 11.

Runbook API 1011 receives a request to register a new workflow document for a customer (step 1101). Runbook API 1011 receives a request, for example, when the customer requests a new service from workflow management service 110 via an API call to Runbook API 1011. For example, Runbook API 1011 may receive a request to register a rightsizing workflow document in central account 1020 for execution on behalf of the customer.

Runbook API 1011 queries workflow metadata 1025 to retrieve sharding metadata (step 1103). This metadata identifies the accounts associated with each workflow document. Based on this metadata, Runbook API 1011 determines the total number or workflow documents allocated to central account 1020.

Runbook API 1011 determines if central account 1010 has capacity to host the new workflow document (step 1105). This determination is based on the number of workflow documents allocated to central account 1020 identified in step 1103. If the number of workflow documents in central account 1020 equal to the compute provider limit (e.g., 5,000), central account 1020 does not have capacity for hosting the new workflow document, and process 1100 proceeds to step 1109. If the number of workflow documents in central account is less than the document limit (e.g., 2,000, 4,000, 4,999, etc.), workflow management service 110 determines that central account 1020 has available capacity, and process 1100 proceeds to step 1107.

When it is determined that central account 1020 has available capacity for new workflow documents, workflow management service 110 allocates the new workflow document to central account 1020 (step 1107). Allocating the workflow document to central account 1020 may include submitting a call to workflow automation engine 1077 to add the workflow document to automation engine 1077.

A component executing the workflow document in central account 1020 (e.g., Loop Lambdas 1023 or Snippets Lambda 1021) assumes a customer-account role (step 1109). This role assumption provides temporary credentials, allowing the component to perform actions on behalf of a customer account (e.g., customer account 150, 160 of FIG. 1A).

The component performs a function on behalf of a customer account using the assumed customer account role (1111). For example, consider a workflow document designed to perform a rightsizing operation on a customer's computing resources. Once the component (e.g., Snippets Lambda 1021) has assumed the customer-account role, it might securely access the customer account (e.g., customer account 150, 160 of FIG. 1A) to retrieve performance metrics from their compute instances. Based on these metrics, the Snippets Lambda 1021 could then initiate actions such as scaling operations, updating configuration settings, or sending notifications if resource usage exceeds predefined thresholds (or transition points, indicators, or boundaries).

Conversely, when it is determined that central account 1020 does not have available capacity, Runbook API 1011 allocates the workflow document to shard account 1030 associated with the customer (step 1113). Allocating the workflow document to shard account 1030 may include assuming, by Runbook API 1011, a shard-account role to provide a call to automation engine 1078 of shard account 1030 to add the workflow document to automation engine 1078. Runbook API 1011 may also assume the shard account-role to configure event bridge 1083 with parameters related to the workflow document, such as triggering conditions for steps in the workflow document.

A component of shard account 1030 (e.g., Snippets Lambda 1087 or Loop Lambdas 1085) assumes a central-account role (step 1115). The component then chains the central account role to a customer-account role to perform a function on behalf of the customer (step 1117). For example, suppose a workflow document is designed to execute a security audit on resources in a customer account (e.g., customer account 150, 160 of FIG. 1). In this case, the component in shard account 1030 (e.g., Snippets Lambda 1087) assumes the central-account role to gain access to centralized monitoring services and then chains that role to the customer's account. With the temporary credentials provided by the chained role, Snippets Lambda 1087 queries the resources in the customer account inventory for compliance with security policies and identifies any misconfigurations. This role-chaining mechanism provides that customer accounts only need to grant role-based permissions to central account 1020, simplifying onboarding procedures.

FIG. 12 illustrates computing system 1201, which is representative of any system or collection of systems in which the various applications, processes, services, and scenarios disclosed herein may be implemented. Examples of computing system 1201 include, but are not limited to server computers, web servers, cloud computing platforms, and data center equipment, as well as any other type of physical or virtual server machine, container, and any variation or combination thereof. (In some examples, computing system 1201 may also be representative of desktop and laptop computers, tablet computers, and the like.)

Computing system 1201 may be implemented as a single apparatus, system, or device or may be implemented in a distributed manner as multiple apparatuses, systems, or devices. Computing system 1201 includes, but is not limited to, processing system 1202, storage system 1203, software 1205, communication interface system 1207, and user interface system 1209. Processing system 1202 is operatively coupled with storage system 1203, communication interface system 1207, and user interface system 1209.

Processing system 1202 loads and executes software 1205 from storage system 1203. Software 1205 includes and implements workflow management processes 1206, which is representative of the processes discussed with respect to the preceding Figures, such as process 200. When executed by processing system 1202, software 1205 directs processing system 1202 to operate as described herein for at least the various processes, operational scenarios, and sequences discussed in the foregoing implementations. Computing system 1201 may optionally include additional devices, features, or functionality not discussed for purposes of brevity.

Referring still to FIG. 12, processing system 1202 may include a microprocessor and other circuitry that retrieves and executes software 1205 from storage system 1203. Processing system multiple processing devices or sub-systems that cooperate in executing program instructions. Examples of processing system 1202 include general purpose central processing units, microcontroller units, graphical processing units, application specific processors, integrated circuits, application specific integrated circuits, and logic devices, as well as any other type of processing device, combinations, or variations thereof.

Storage system 1203 may comprise any computer readable storage media readable by processing system 1202 and capable of storing software 1205. Storage system 1203 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 1203 may be implemented as a single storage device but may also be implemented across multiple storage devices or sub-systems co-located or distributed relative to each other. Storage system 1203 may comprise additional elements, such as a controller capable of communicating with processing system 1202 or possibly other systems.

Software 1205 (including workflow management processes 1206) may be implemented in program instructions and among other functions may, when executed by processing system 1202, direct processing system 1202 to operate as described with respect to the various operational scenarios, sequences, and processes illustrated herein. For example, software 1205 may include program instructions for implementing resource management processes and procedures as described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for”, but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. A computer-implemented method for proactively provisioning shard accounts in a workflow management service comprising:
allocating a plurality of workflow documents to a central account of a workflow management service, wherein the central account hosts and executes the plurality of workflow documents on behalf of one or more customers of the workflow management service;
identifying a number of the plurality of workflow documents allocated to the central account;
determining that the number of workflow documents has exceeded a threshold indicating that the number approaches a document limit imposed by a compute provider; and
provisioning a shard account of the workflow management service in response to the determination, wherein the shard account is configured to execute additional workflow documents, thereby maintaining operational scalability while operating within the document limit.

2. The computer-implemented method of claim 1, wherein the shard account is provisioned with execution services for executing workflow documents allocated by the central account.

3. The computer-implemented method of claim 2, further comprising maintaining, by the central account, workflow metadata associating each the shard account with allocated workflow documents for the shard accounts.

4. The computer-implemented method of claim 1, further comprising:
identifying a rate of new workflow document requests received by the central account over time; and
determining the threshold based on the rate of new workflow document requests.

5. The computer-implemented method of claim 1, further comprising:
receiving, from a customer, a request to register a new workflow document in the workflow management service;
determining that the central account does not have available capacity to execute the new workflow document; and,
allocating, in response to the determination that the central account does not have available capacity, the new workflow document to the shard account.

6. The computer-implemented method of claim 5, further comprising, during execution of the new workflow document in the shard account:
calling, by an automation engine of the shard account, a first execution function of the shard account, and
calling, by the automation engine, a second execution function of the central account.

7. The computer-implemented method of claim 6, wherein:
the first execution function comprises a looping function identified in the new workflow document; and
the second execution function includes a discrete task.

8. The computer-implemented method of claim 5, further comprising:
receiving, at an application programming interface (API) of the central account, a request for execution data associated with the workflow document; and
retrieving, by the central account and via a cross-account gateway, the execution data from an execution cache of the shard account.

9. The computer-implemented method of claim 5, further comprising:
granting a customer-account role to the central account, wherein the customer-account role permits the central account to execute workflows on behalf of a customer account associated with the customer;
granting a central-account role to the shard account, wherein the central-account role permits the shard account to execute workflows on behalf of the central account; and
executing the workflow document in the shard account by chaining the central-account role to the customer-account role.

10. A system to manage workflow documents in a workflow management service comprising:
one or more processors; and
one or more memories operably coupled to the one or more processors and having stored thereon software instructions that, upon execution by the one or more processors, cause the one or more processors to:
receive, at a central account of the workflow management service, a workflow request from a customer to register a workflow document for managing compute resources of the customer;
determine that the central account does not have available capacity for the workflow document; and
allocate, in response to the determination, the workflow document to a shard account of the workflow management service, wherein the shard account is configured to execute workflow documents on behalf of the central account.

11. The system of claim 10, wherein the software instructions comprise further instructions that, upon execution by the one or more processors, cause the one or more processors to, during execution of the workflow document in the shard account:
call, by an automation engine of the shard account, a first execution function of the shard account, and
call, by the automation engine, a second execution function of the central account.

12. The system of claim 11, wherein:
the first execution function comprises a looping function identified in the workflow document; and
the second execution function comprises a discrete task.

13. The system of claim 10, wherein the software instructions comprise further instructions that, upon execution by the one or more processors, cause the one or more processors to:
receive, at an application programming interface (API) of the central account, a request for execution data associated with the workflow document; and
retrieve, by the central account and via a cross-account gateway, the execution data from an execution cache of the shard account.

14. The system of claim 10, wherein the software instructions comprise further instructions that, upon execution by the one or more processors, cause the one or more processors to:
determine that a number of workflow documents in the shard account has exceeded a threshold indicating that the number approaches a document limit imposed by a compute provider; and
provision an additional shard account of the workflow management service in response to the determination.

15. The system of claim 10, wherein the software instructions comprise further instructions that, upon execution by the one or more processors, cause the one or more processors to:
grant a customer account role to the central account, wherein the customer account role permits the central account to execute workflows on behalf of a customer account associated with the customer;
grant a central account role to the shard account, wherein the central account role permits the shard account to execute workflows on behalf of the central account; and
execute the workflow document in the shard account by chaining the central account role to the customer account role.

16. A computer-readable storage media device having program instructions stored thereon that, upon execution by one or more processors, cause the one or more processors to:
grant a customer account role to a central account of a workflow management service, wherein the customer account role permits the central account to execute workflow documents on behalf of a customer account, wherein the central account is configured to:
grant a central account role to a shard account of the workflow management service, wherein the central account role permits the shard account to execute workflows on behalf of the central account; and
execute the workflow document in the shard account by chaining the central account role to the customer account role.

17. The computer-readable storage media device of claim 16, wherein the program instructions comprise further instructions that, upon execution by one or more processors, cause the one or more processors to:
receive a workflow request from a customer to register a workflow document for managing compute resources of the customer;
determine that the central account does not have available capacity for the workflow document; and
allocate, in response to the determination, the workflow document to a first shard account of the one or more shard accounts.

18. The computer-readable storage media device of claim 17, wherein the program instructions comprise further instructions that, upon execution by one or more processors, cause the one or more processors to:
receive, at an application programming interface (API) of the central account, a request for execution data associated with the workflow document; and
retrieve, by the central account and via a cross-account gateway, the execution data from an execution cache of the first shard account.

19. The computer-readable storage media device of claim 17, wherein the program instructions comprise further instructions that, upon execution by one or more processors, cause the one or more processors to:
update, in response to allocating the workflow document, workflow metadata associating each the shard account with the workflow document allocated to the first shard account.

20. The computer-readable storage media device of claim 17, wherein the workflow document defines an automated process that the shard account executes on behalf of the customer.
